(19) United States
(12) Patent Application Publication
(10) Pub. No.: US 2025/0039244 A1
(43) Pub. Date: Jan. 30, 2025

(54) SECURITY FUNCTIONS BASED ON JOB CRITICALITY

(71) Applicant: Tenable, Inc., Columbia, MD (US)

(72) Inventors: Slawomir Grzonkowski, Dublin (IE); Carlos Siqueira do Amaral, Dublin (IE)

(21) Appl. No.: 18/358,613

(22) Filed: Jul. 25, 2023

(51) Int. Cl. H04L 9/40

(52) U.S. Cl. CPC H04L 63/205; H04L 63/105; H04L 63/1433

(57) ABSTRACT

In an aspect, a component determines a role, a title and a management structure associated with a digital identity. The component determines a set of titles that are analogous to the title associated with the digital identity. The component determines a job criticality of the digital identity based on the role associated with the digital identity, the title associated with the digital identity, the set of titles that are analogous to the title associated with the digital identity, and the management structure associated with the digital identity. The component performs one or more security functions based on the job criticality of the digital identity.

### TECHNICAL FIELD

Aspects relate to security functions based on job criticality.

### BACKGROUND

Every modern organization uses software to view, manage and edit their employees' data. Parts of this data may be shared with third party organizations to provide various services such as threat, misconfiguration or vulnerability detection.

The number of misconfiguration or vulnerability results generated from such services is often overwhelming for the company receiving it; and in many cases, it takes too much time to find and address relevant findings before it is too late. Thus, there are various ideas to prioritize presented findings. For example, in vulnerability detection products, vulnerabilities are typically prioritized by vulnerability severity. This is usually straightforward, as when a vulnerability is discovered, that vulnerability is assigned a severity score.

However, in terms of company risk exposure, vulnerability severity is only one relevant parameter. Another relevant parameter relates to the owner of the asset with a vulnerability. For example, a compromised asset operated by a janitor employed by a company will generally be associated with less strategic risk to the company than a comprised asset operated by a chief executive officer (CEO) of the company. Automating an allocation of job criticality to digital identifies is difficult for various reasons, such as disparities in title names between companies, disparities in job responsibilities associated with the same/similar titles between companies, and so on.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating a component includes determining a role associated with a digital identity, the role comprising a set of permissions associated with at least one asset, a network, or both; determining a title associated with the digital identity; determining a set of titles that are analogous to the title associated with the digital identity; determining a management structure associated with the digital identity, the management structure comprising a first set of digital identities subordinate to the digital identity, a second set of digital identities to which the digital identity is subordinate, or a combination thereof; determining a job criticality of the digital identity based on the role associated with the digital identity, the title associated with the digital identity, the set of titles that are analogous to the title associated with the digital identity, and the management structure associated with the digital identity; and performing one or more security functions based on the job criticality of the digital identity.

In some aspects, the determination of the job criticality of the digital identity comprises: determining a set of scores associated with the set of permissions; and deriving a role score based on the set of scores, wherein the job criticality of the digital identity is a function of the role score.

In some aspects, the determination of the job criticality of the digital identity comprises: generating the set of titles that are that are analogous to the title associated with the digital identity using a machine-learning (ML) model; tokenizing each title in the set of titles via a natural language processing (NPL) model to produce a set of token scores associated with each extracted token; deriving a set of title scores for the set of titles based on the set of token scores for the respective title; and deriving a title score for the title associated with the digital identity based on the set of title scores, wherein the job criticality of the digital identity is a function of the title score.

In some aspects, the deriving of the title score for the title associated with the digital identity is based on a weighting of each title score of the set of title scores is that is based on a similarity confidence level between the title associated with the digital identity and the respective title from the set of titles.

In some aspects, the tokenizing comprises extracting, from each title in the set of titles, one or more responsibility tokens, one or more function tokens, one or more scope tokens, or any combination thereof, and assigning each extracted token a respective token score.

In some aspects, the ML model comprises a neutral network (NN).

In some aspects, the determination of the job criticality of the digital identity comprises: deriving a management score for the digital identity based on a number of digital identities in the first set of digital identities, the second set of digital identities, or both, wherein the job criticality of the digital identity is a function of the management score.

In some aspects, the job criticality of the digital identity is based on: a role score that is based on the role associated with the digital identity, a title score that is based on the title associated with the digital identity, and a management score that is based on the management structure associated with the digital identity.

In some aspects, the role associated with the digital identity is defined in accordance with a role based access control (RBAC) system.

In some aspects, the title is input as a string and the job criticality is output as a numeric value or a numeric label.

In some aspects, the set of permissions associated with at least one asset, a network, or both, comprises a set of entitlements.

In some aspects, each entitlement of the set of entitlements is associated with one or more actions permitted in association with the at least one asset, the network, or both.

In some aspects, the one or more actions comprise a read action, a restricted read action, a write action, a delete action, a restore action, an enable action, a disable action, an update action, a manage action, or any combination thereof.

In some aspects, the one or more actions are each ranked in accordance with an action ranking table.

In some aspects, the method includes deriving an entitlement score based on the set of entitlements, wherein the determination of the job criticality of the digital identity is based on the entitlement score.

In some aspects, the entitlement score is derived based on a neural network applied with respect to each of the one or more actions.

In some aspects, the neural network outputs an embedding for each of the one or more actions, wherein each embedding comprises a vector that encodes semantic information of the respective action in a mathematical space.

In some aspects, each embedding is input to a clustering algorithm that assigns each action to a cluster in a set of clusters, wherein each cluster is associated with a particular group of similar actions, wherein each cluster is associated with a cluster score, and wherein each cluster score for each action is factored into the respective entitlement score.

In some aspects, the job criticality of the digital identity is not based on any vulnerability or exploit associated with the at least one asset, the network, or both.

In some aspects, the one or more security functions comprise: allocating a job criticality-based priority to vulnerability and/or exploit remediation to one or more assets associated with the digital identity.

In an aspect, a component includes one or more memories; and one or more processors communicatively coupled to the one or more memories, the one or more processors, either alone or in combination, configured to: determine a role associated with a digital identity, the role comprising a set of permissions associated with at least one asset, a network, or both; determine a title associated with the digital identity; determine a set of titles that are analogous to the title associated with the digital identity; determine a management structure associated with the digital identity, the management structure comprising a first set of digital identities subordinate to the digital identity, a second set of digital identities to which the digital identity is subordinate, or a combination thereof; determine a job criticality of the digital identity based on the role associated with the digital identity, the title associated with the digital identity, the set of titles that are analogous to the title associated with the digital identity, and the management structure associated with the digital identity; and perform one or more security functions based on the job criticality of the digital identity.

In some aspects, the determination of the job criticality of the digital identity comprises: determine a set of scores associated with the set of permissions; and derive a role score based on the set of scores, wherein the job criticality of the digital identity is a function of the role score.

In some aspects, the determination of the job criticality of the digital identity comprises: generate the set of titles that are that are analogous to the title associated with the digital identity using a machine-learning (ML) model; tokenize each title in the set of titles via a natural language processing (NPL) model to produce a set of token scores associated with each extracted token; derive a set of title scores for the set of titles based on the set of token scores for the respective title; and derive a title score for the title associated with the digital identity based on the set of title scores, wherein the job criticality of the digital identity is a function of the title score.

In some aspects, the deriving of the title score for the title associated with the digital identity is based on a weighting of each title score of the set of title scores is that is based on a similarity confidence level between the title associated with the digital identity and the respective title from the set of titles.

In some aspects, the tokenizing comprises extracting, from each title in the set of titles, one or more responsibility tokens, one or more function tokens, one or more scope tokens, or any combination thereof, and assigning each extracted token a respective token score.

In some aspects, the ML model comprises a neutral network (NN).

In some aspects, the determination of the job criticality of the digital identity comprises: derive a management score for the digital identity based on a number of digital identities in the first set of digital identities, the second set of digital identities, or both, wherein the job criticality of the digital identity is a function of the management score.

In some aspects, the job criticality of the digital identity is based on: a role score that is based on the role associated with the digital identity, a title score that is based on the title associated with the digital identity, and a management score that is based on the management structure associated with the digital identity.

In some aspects, the role associated with the digital identity is defined in accordance with a role based access control (RBAC) system.

In some aspects, the title is input as a string and the job criticality is output as a numeric value or a numeric label.

In some aspects, the set of permissions associated with at least one asset, a network, or both, comprises a set of entitlements.

In some aspects, each entitlement of the set of entitlements is associated with one or more actions permitted in association with the at least one asset, the network, or both.

In some aspects, the one or more actions comprise a read action, a restricted read action, a write action, a delete action, a restore action, an enable action, a disable action, an update action, a manage action, or any combination thereof.

In some aspects, the one or more actions are each ranked in accordance with an action ranking table.

In some aspects, the one or more processors, either alone or in combination, are further configured to: derive an entitlement score based on the set of entitlements, wherein the determination of the job criticality of the digital identity is based on the entitlement score.

In some aspects, the entitlement score is derived based on a neural network applied with respect to each of the one or more actions.

In some aspects, the neural network outputs an embedding for each of the one or more actions, wherein each embedding comprises a vector that encodes semantic information of the respective action in a mathematical space.

In some aspects, each embedding is input to a clustering algorithm that assigns each action to a cluster in a set of clusters, wherein each cluster is associated with a particular group of similar actions, wherein each cluster is associated with a cluster score, and wherein each cluster score for each action is factored into the respective entitlement score.

In some aspects, the job criticality of the digital identity is not based on any vulnerability or exploit associated with the at least one asset, the network, or both.

In some aspects, the one or more security functions comprise: allocate a job criticality-based priority to vulnerability and/or exploit remediation to one or more assets associated with the digital identity.

In an aspect, a component includes means for determining a role associated with a digital identity, the role comprising a set of permissions associated with at least one asset, a network, or both; means for determining a title associated with the digital identity; means for determining a set of titles that are analogous to the title associated with the digital identity; means for determining a management structure associated with the digital identity, the management structure comprising a first set of digital identities subordinate to the digital identity, a second set of digital identities to which the digital identity is subordinate, or a combination thereof; means for determining a job criticality of the digital identity based on the role associated with the digital identity, the title associated with the digital identity, the set of titles that are analogous to the title associated with the digital identity, and the management structure associated with the digital identity; and means for performing one or more security functions based on the job criticality of the digital identity.

In some aspects, the determination of the job criticality of the digital identity comprises: means for determining a set of scores associated with the set of permissions; and means for deriving a role score based on the set of scores, wherein the job criticality of the digital identity is a function of the role score.

In some aspects, the determination of the job criticality of the digital identity comprises: means for generating the set of titles that are that are analogous to the title associated with the digital identity using a machine-learning (ML) model; means for tokenizing each title in the set of titles via a natural language processing (NPL) model to produce a set of token scores associated with each extracted token; means for deriving a set of title scores for the set of titles based on the set of token scores for the respective title; and means for deriving a title score for the title associated with the digital identity based on the set of title scores, wherein the job criticality of the digital identity is a function of the title score.

In some aspects, the deriving of the title score for the title associated with the digital identity is based on a weighting of each title score of the set of title scores is that is based on a similarity confidence level between the title associated with the digital identity and the respective title from the set of titles.

In some aspects, the tokenizing comprises extracting, from each title in the set of titles, one or more responsibility tokens, one or more function tokens, one or more scope tokens, or any combination thereof, and assigning each extracted token a respective token score.

In some aspects, the ML model comprises a neutral network (NN).

In some aspects, the determination of the job criticality of the digital identity comprises: means for deriving a management score for the digital identity based on a number of digital identities in the first set of digital identities, the second set of digital identities, or both, wherein the job criticality of the digital identity is a function of the management score.

In some aspects, the job criticality of the digital identity is based on: a role score that is based on the role associated with the digital identity, a title score that is based on the title associated with the digital identity, and a management score that is based on the management structure associated with the digital identity.

In some aspects, the role associated with the digital identity is defined in accordance with a role based access control (RBAC) system.

In some aspects, the title is input as a string and the job criticality is output as a numeric value or a numeric label.

In some aspects, the set of permissions associated with at least one asset, a network, or both, comprises a set of entitlements.

In some aspects, each entitlement of the set of entitlements is associated with one or more actions permitted in association with the at least one asset, the network, or both.

In some aspects, the one or more actions comprise a read action, a restricted read action, a write action, a delete action, a restore action, an enable action, a disable action, an update action, a manage action, or any combination thereof.

In some aspects, the one or more actions are each ranked in accordance with an action ranking table.

In some aspects, the method includes means for deriving an entitlement score based on the set of entitlements, wherein the determination of the job criticality of the digital identity is based on the entitlement score.

In some aspects, the entitlement score is derived based on a neural network applied with respect to each of the one or more actions.

In some aspects, the neural network outputs an embedding for each of the one or more actions, wherein each embedding comprises a vector that encodes semantic information of the respective action in a mathematical space.

In some aspects, each embedding is input to a clustering algorithm that assigns each action to a cluster in a set of clusters, wherein each cluster is associated with a particular group of similar actions, wherein each cluster is associated with a cluster score, and wherein each cluster score for each action is factored into the respective entitlement score.

In some aspects, the job criticality of the digital identity is not based on any vulnerability or exploit associated with the at least one asset, the network, or both.

In some aspects, the one or more security functions comprise: means for allocating a job criticality-based priority to vulnerability and/or exploit remediation to one or more assets associated with the digital identity.

In an aspect, a non-transitory computer-readable medium storing computer-executable instructions that, when executed by a component, cause the component to: determine a role associated with a digital identity, the role comprising a set of permissions associated with at least one asset, a network, or both; determine a title associated with the digital identity; determine a set of titles that are analogous to the title associated with the digital identity; determine a management structure associated with the digital identity, the management structure comprising a first set of digital identities subordinate to the digital identity, a second set of digital identities to which the digital identity is subordinate, or a combination thereof; determine a job criticality of the digital identity based on the role associated with the digital identity, the title associated with the digital identity, the set of titles that are analogous to the title associated with the digital identity, and the management structure associated with the digital identity; and perform one or more security functions based on the job criticality of the digital identity.

In some aspects, the determination of the job criticality of the digital identity comprises: determine a set of scores associated with the set of permissions; and derive a role score based on the set of scores, wherein the job criticality of the digital identity is a function of the role score.

In some aspects, the determination of the job criticality of the digital identity comprises: generate the set of titles that are that are analogous to the title associated with the digital identity using a machine-learning (ML) model; tokenize each title in the set of titles via a natural language processing (NPL) model to produce a set of token scores associated with each extracted token; derive a set of title scores for the set of titles based on the set of token scores for the respective title; and derive a title score for the title associated with the digital identity based on the set of title scores, wherein the job criticality of the digital identity is a function of the title score.

In some aspects, the deriving of the title score for the title associated with the digital identity is based on a weighting of each title score of the set of title scores is that is based on a similarity confidence level between the title associated with the digital identity and the respective title from the set of titles.

In some aspects, the tokenizing comprises extracting, from each title in the set of titles, one or more responsibility tokens, one or more function tokens, one or more scope tokens, or any combination thereof, and assigning each extracted token a respective token score.

In some aspects, the ML model comprises a neutral network (NN).

In some aspects, the determination of the job criticality of the digital identity comprises: derive a management score for the digital identity based on a number of digital identities in the first set of digital identities, the second set of digital identities, or both, wherein the job criticality of the digital identity is a function of the management score.

In some aspects, the job criticality of the digital identity is based on: a role score that is based on the role associated with the digital identity, a title score that is based on the title associated with the digital identity, and a management score that is based on the management structure associated with the digital identity.

In some aspects, the role associated with the digital identity is defined in accordance with a role based access control (RBAC) system.

In some aspects, the title is input as a string and the job criticality is output as a numeric value or a numeric label.

In some aspects, the set of permissions associated with at least one asset, a network, or both, comprises a set of entitlements.

In some aspects, each entitlement of the set of entitlements is associated with one or more actions permitted in association with the at least one asset, the network, or both.

In some aspects, the one or more actions comprise a read action, a restricted read action, a write action, a delete action, a restore action, an enable action, a disable action, an update action, a manage action, or any combination thereof.

In some aspects, the one or more actions are each ranked in accordance with an action ranking table.

In some aspects, computer-executable instructions that, when executed by the component, cause the component to:

In some aspects, the entitlement score is derived based on a neural network applied with respect to each of the one or more actions.

In some aspects, the neural network outputs an embedding for each of the one or more actions, wherein each embedding comprises a vector that encodes semantic information of the respective action in a mathematical space.

In some aspects, each embedding is input to a clustering algorithm that assigns each action to a cluster in a set of clusters, wherein each cluster is associated with a particular group of similar actions, wherein each cluster is associated with a cluster score, and wherein each cluster score for each action is factored into the respective entitlement score.

In some aspects, the job criticality of the digital identity is not based on any vulnerability or exploit associated with the at least one asset, the network, or both.

In some aspects, the one or more security functions comprise: allocate a job criticality-based priority to vulnerability and/or exploit remediation to one or more assets associated with the digital identity.

Other objects and advantages associated with the aspects disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIG. 1 illustrates an exemplary network having various assets that can be managed using a vulnerability management system, according to various aspects.

FIG. 2 illustrates another exemplary network having various assets that can be managed using a vulnerability management system, according to various aspects.

FIG. 3 illustrates a diagram of an example system suitable for interactive remediation of vulnerabilities of web applications based on scanning of web applications.

FIG. 4 illustrates a server, according to aspects of the disclosure.

FIG. 5 generally illustrates a user equipment (UE) in accordance with aspects of the disclosure.

FIG. 6 illustrates a process, in accordance with aspects of the disclosure.

FIG. 7 illustrates an example neural network, according to aspects of the disclosure.

FIG. 8 illustrates a Role Based Access Control (RBAC) system, according to aspects of the disclosure.

FIG. 9 illustrates a first example implementation of the process of FIG. 6 in accordance with aspects of the disclosure.

FIG. 10 illustrates the first example implementation of the process of FIG. 6 in accordance with aspects of the disclosure.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

As used herein, the term “asset” and variants thereof may generally refer to any suitable uniquely defined electronic object that has been identified via one or more preferably unique but possibly non-unique identifiers or identification attributes (e.g., a universally unique identifier (UUID), a Media Access Control (MAC) address, a Network BIOS (NetBIOS) name, a Fully Qualified Domain Name (FQDN), an Internet Protocol (IP) address, a tag, a CPU ID, an instance ID, a Secure Shell (SSH) key, a user-specified identifier such as a registry setting, file content, information contained in a record imported from a configuration management database (CMDB), etc.). For example, the various aspects and embodiments described herein contemplate that an asset may be a physical electronic object such as, without limitation, a desktop computer, a laptop computer, a server, a storage device, a network device, a phone, a tablet, a wearable device, an Internet of Things (IoT) device, a set-top box or media player, etc. Furthermore, the various aspects and embodiments described herein contemplate that an asset may be a virtual electronic object such as, without limitation, a cloud instance, a virtual machine instance, a container, etc., a web application that can be addressed via a Uniform Resource Identifier (URI) or Uniform Resource Locator (URL), and/or any suitable combination thereof. Those skilled in the art will appreciate that the above-mentioned examples are not intended to be limiting but instead are intended to illustrate the ever-evolving types of resources that can be present in a modern computer network. As such, the various aspects and embodiments to be described in further detail below may include various techniques to manage network vulnerabilities according to an asset-based (rather than host-based) approach, whereby the various aspects and embodiments described herein contemplate that a particular asset can have multiple unique identifiers (e.g., a UUID and a MAC address) and that a particular asset can have multiples of a given unique identifier (e.g., a device with multiple network interface cards (NICs) may have multiple unique MAC addresses). Furthermore, as will be described in further detail below, the various aspects and embodiments described herein contemplate that a particular asset can have one or more dynamic identifiers that can change over time (e.g., an IP address) and that different assets may share a non-unique identifier (e.g., an IP address can be assigned to a first asset at a first time and assigned to a second asset at a second time). Accordingly, the identifiers or identification attributes used to define a given asset may vary with respect to uniqueness and the probability of multiple occurrences, which may be taken into consideration in reconciling the particular asset to which a given data item refers. Furthermore, in the elastic licensing model described herein, an asset may be counted as a single unit of measurement for licensing purposes.

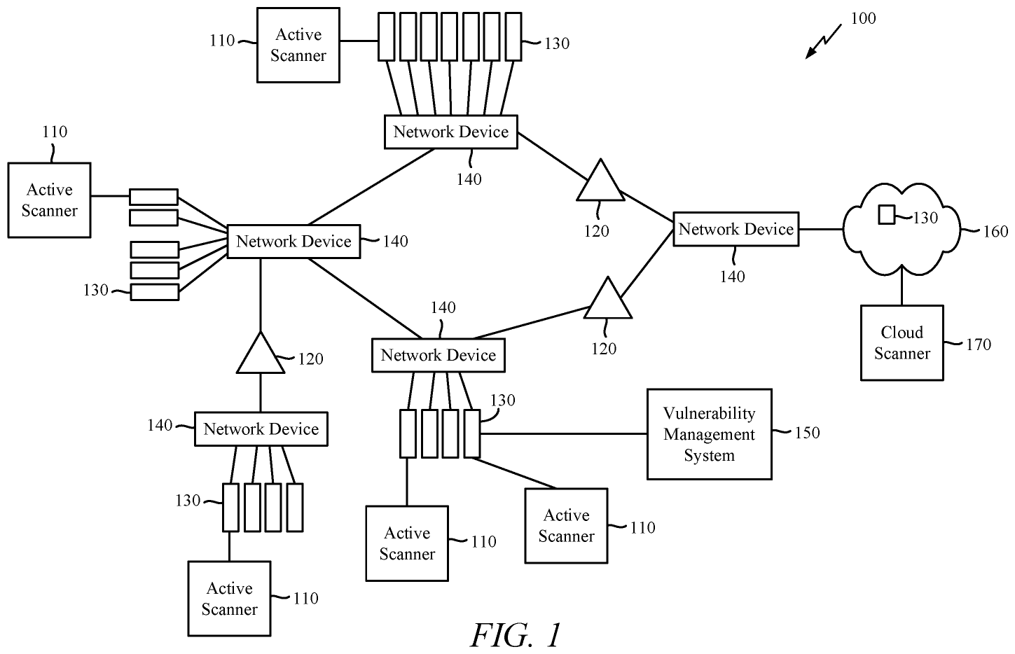

According to various aspects, FIG. 1 illustrates an exemplary network 100 having various assets 130 that are interconnected via one or more network devices 140 and managed using a vulnerability management system 150. More particularly, as noted above, the assets 130 may include various types, including traditional assets (e.g., physical desktop computers, servers, storage devices, etc.), web applications that run self-supporting code, Internet of Things (IoT) devices (e.g., consumer appliances, conference room utilities, cars parked in office lots, physical security systems, etc.), mobile or bring-your-own-device (BYOD) resources (e.g., laptop computers, mobile phones, tablets, wearables, etc.), virtual objects (e.g., containers and/or virtual machine instances that are hosted within the network 100, cloud instances hosted in off-site server environments, etc.). Those skilled in the art will appreciate that the assets 130 listed above are intended to be exemplary only and that the assets 130 associated with the network 100 may include any suitable combination of the above-listed asset types and/or other suitable asset types. Furthermore, in various embodiments, the one or more network devices 140 may include wired and/or wireless access points, small cell base stations, network routers, hubs, spanned switch ports, network taps, choke points, and so on, wherein the network devices 140 may also be included among the assets 130 despite being labelled with a different reference numeral in FIG. 1.

According to various aspects, the assets 130 that make up the network 100 (including the network devices 140 and any assets 130 such as cloud instances that are hosted in an off-site server environment or other remote network 160) may collectively form an attack surface that represents the sum total of resources through which the network 100 may be vulnerable to a cyberattack. As will be apparent to those skilled in the art, the diverse nature of the various assets 130 make the network 100 substantially dynamic and without clear boundaries, whereby the attack surface may expand and contract over time in an often unpredictable manner thanks to trends like BYOD and DevOps, thus creating security coverage gaps and leaving the network 100 vulnerable. For example, due at least in part to exposure to the interconnectedness of new types of assets 130 and abundant software changes and updates, traditional assets like physical desktop computers, servers, storage devices, and so on are more exposed to security vulnerabilities than ever before. Moreover, vulnerabilities have become more and more common in self-supported code like web applications as organizations seek new and innovative ways to improve operations. Although delivering custom applications to employees, customers, and partners can increase revenue, strengthen customer relationships, and improve efficiency, these custom applications may have flaws in the underlying code that could expose the network 100 to an attack. In other examples, IoT devices are growing in popularity and address modern needs for connectivity but can also add scale and complexity to the network 100, which may lead to security vulnerabilities as IoT devices are often designed without security in mind. Furthermore, trends like mobility, BYOD, etc. mean that more and more users and devices may have access to the network 100, whereby the idea of a static network with devices that can be tightly controlled is long gone. Further still, as organizations adopt DevOps practices to deliver applications and services faster, there is a shift in how software is built and short-lived assess like containers and virtual machine instances are used. While these types of virtual assets can help organizations increase agility, they also create significant new exposure for security teams. Even the traditional idea of a perimeter for the network 100 is outdated, as many organizations are connected to cloud instances that are hosted in off-site server environments, increasing the difficulty to accurately assess vulnerabilities, exposure, and overall risk from cyberattacks that are also becoming more sophisticated, more prevalent, and more likely to cause substantial damage.

Accordingly, to address the various security challenges that may arise due to the network 100 having an attack surface that is substantially elastic, dynamic, and without boundaries, the vulnerability management system 150 may include various components that are configured to help detect and remediate vulnerabilities in the network 100.

More particularly, the network 100 may include one or more active scanners 110 configured to communicate packets or other messages within the network 100 to detect new or changed information describing the various network devices 140 and other assets 130 in the network 100. For example, in one implementation, the active scanners 110 may perform credentialed audits or uncredentialed scans to scan certain assets 130 in the network 100 and obtain information that may then be analyzed to identify potential vulnerabilities in the network 100. As used herein “credentialed” scans rely upon user credential(s) for authentication. Credentialed scans can perform a wider variety of checks than non-credentialed scans, which can result in more accurate scan results. Non-credentialed scans by contrast do not rely upon user credential(s) for authentication. More particularly, in one implementation, the credentialed audits may include the active scanners 110 using suitable authentication technologies to log into and obtain local access to the assets 130 in the network 100 and perform any suitable operation that a local user could perform thereon without necessarily requiring a local agent. Alternatively and/or additionally, the active scanners 110 may include one or more agents (e.g., lightweight programs) locally installed on a suitable asset 130 and given sufficient privileges to collect vulnerability, compliance, and system data to be reported back to the vulnerability management system 150. As such, the credentialed audits performed with the active scanners 110 may generally be used to obtain highly accurate host-based data that includes various client-side issues (e.g., missing patches, operating system settings, locally running services, etc.). On the other hand, the uncredentialed audits may generally include network-based scans that involve communicating packets or messages to the appropriate asset(s) 130 and observing responses thereto in order to identify certain vulnerabilities (e.g., that a particular asset 130 accepts spoofed packets that may expose a vulnerability that can be exploited to close established connections). Furthermore, as shown in FIG. 1, one or more cloud scanners 170 may be configured to perform a substantially similar function as the active scanners 110, except that the cloud scanners 170 may also have the ability to scan assets 130 like cloud instances that are hosted in a remote network 160 (e.g., an off-site server environment or other suitable cloud infrastructure).

Additionally, in various implementations, one or more passive scanners 120 may be deployed within the network 100 to observe or otherwise listen to traffic in the network 100, to identify further potential vulnerabilities in the network 100, and to detect activity that may be targeting or otherwise attempting to exploit previously identified vulnerabilities. In one implementation, as noted above, the active scanners 110 may obtain local access to one or more of the assets 130 in the network 100 (e.g., in a credentialed audit) and/or communicate various packets or other messages within the network 100 to illicit responses from one or more of the assets 130 (e.g., in an uncredentialed scan). In contrast, the passive scanners 120 may generally observe (or “sniff”) various packets or other messages in the traffic traversing the network 100 to passively scan the network 100. In particular, the passive scanners 120 may reconstruct one or more sessions in the network 100 from information contained in the sniffed traffic, wherein the reconstructed sessions may then be used in combination with the information obtained with the active scanners 110 to build a model or topology describing the network 100. For example, in one implementation, the model or topology built from the information obtained with the active scanners 110 and the passive scanners 120 may describe any network devices 140 and/or other assets 130 that are detected or actively running in the network 100, any services or client-side software actively running or supported on the network devices 140 and/or other assets 130, and trust relationships associated with the various network devices 140 and/or other assets 130, among other things. In one implementation, the passive scanners 120 may further apply various signatures to the information in the observed traffic to identify vulnerabilities in the network 100 and determine whether any data in the observed traffic potentially targets such vulnerabilities. In one implementation, the passive scanners 120 may observe the network traffic continuously, at periodic intervals, on a pre-configured schedule, or in response to determining that certain criteria or conditions have been satisfied. The passive scanners 120 may then automatically reconstruct the network sessions, build or update the network model, identify the network vulnerabilities, and detect the traffic potentially targeting the network vulnerabilities in response to new or changed information in the network 100.

In one implementation, as noted above, the passive scanners 120 may generally observe the traffic traveling across the network 100 to reconstruct one or more sessions occurring in the network 100, which may then be analyzed to identify potential vulnerabilities in the network 100 and/or activity targeting the identified vulnerabilities, including one or more of the reconstructed sessions that have interactive or encrypted characteristics (e.g., due to the sessions including packets that had certain sizes, frequencies, randomness, or other qualities that may indicate potential backdoors, covert channels, or other vulnerabilities in the network 100). Accordingly, the passive scanners 120 may monitor the network 100 in substantially real-time to detect any potential vulnerabilities in the network 100 in response to identifying interactive or encrypted sessions in the packet stream (e.g., interactive sessions may typically include activity occurring through keyboard inputs, while encrypted sessions may cause communications to appear random, which can obscure activity that installs backdoors or rootkit applications). Furthermore, in one implementation, the passive scanners 120 may identify changes in the network 100 from the encrypted and interactive sessions (e.g., an asset 130 corresponding to a new e-commerce server may be identified in response to the passive scanners 120 observing an encrypted and/or interactive session between a certain host located in the remote network 160 and a certain port that processes electronic transactions). In one implementation, the passive scanners 120 may observe as many sessions in the network 100 as possible to provide optimal visibility into the network 100 and the activity that occurs therein. For example, in one implementation, the passive scanners 120 may be deployed at any suitable location that enables the passive scanners 120 to observe traffic going into and/or out of one or more of the network devices 140. In one implementation, the passive scanners 120 may be deployed on any suitable asset 130 in the network 100 that runs a suitable operating system (e.g., a server, host, or other device that runs Red Hat Linux or FreeBSD open source operating system, a UNIX, Windows, or Mac OS X operating system, etc.).

Furthermore, in one implementation, the various assets and vulnerabilities in the network 100 may be managed using the vulnerability management system 150, which may provide a unified security monitoring solution to manage the vulnerabilities and the various assets 130 that make up the network 100. In particular, the vulnerability management system 150 may aggregate the information obtained from the active scanners 110 and the passive scanners 120 to build or update the model or topology associated with the network 100, which may generally include real-time information describing various vulnerabilities, applied or missing patches, intrusion events, anomalies, event logs, file integrity audits, configuration audits, or any other information that may be relevant to managing the vulnerabilities and assets in the network 100. As such, the vulnerability management system 150 may provide a unified interface to mitigate and manage governance, risk, and compliance in the network 100.

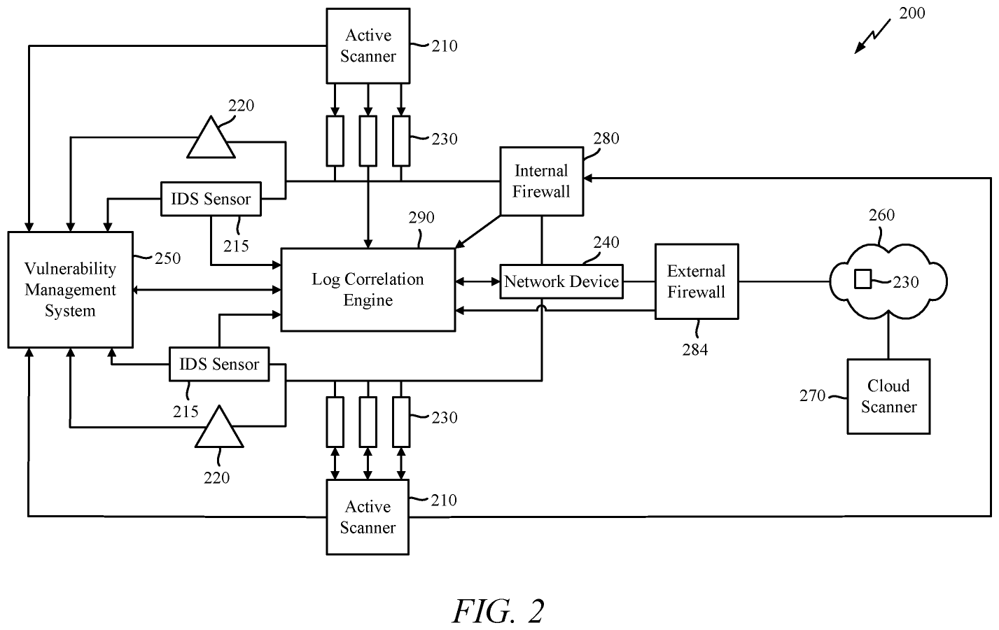

According to various aspects, FIG. 2 illustrates another exemplary network 200 with various assets 230 that can be managed using a vulnerability management system 250. In particular, the network 200 shown in FIG. 2 may have various components and perform substantially similar functionality as described above with respect to the network 100 shown in FIG. 1. For example, in one implementation, the network 200 may include one or more active scanners 210 and/or cloud scanners 270, which may interrogate assets 230 in the network 200 to build a model or topology of the network 200 and identify various vulnerabilities in the network 200, one or more passive scanners 220 that can passively observe traffic in the network 200 to further build the model or topology of the network 200, identify further vulnerabilities in the network 200, and detect activity that may potentially target or otherwise exploit the vulnerabilities. Additionally, in one implementation, a log correlation engine 290 may be arranged to receive logs containing events from various sources distributed across the network 200. For example, in one implementation, the logs received at the log correlation engine 290 may be generated by internal firewalls 280, external firewalls 284, network devices 240, assets 230, operating systems, applications, or any other suitable resource in the network 200. Accordingly, in one implementation, the information obtained from the active scanners 210, the cloud scanners 270, the passive scanners 220, and the log correlation engine 290 may be provided to the vulnerability management system 250 to generate or update a comprehensive model associated with the network 200 (e.g., topologies, vulnerabilities, assets, etc.).

In one implementation, the active scanners 210 may be strategically distributed in locations across the network 200 to reduce stress on the network 200. For example, the active scanners 210 may be distributed at different locations in the network 200 in order to scan certain portions of the network 200 in parallel, whereby an amount of time to perform the active scans may be reduced. Furthermore, in one implementation, one or more of the active scanners 210 may be distributed at a location that provides visibility into portions of a remote network 260 and/or offloads scanning functionality from the managed network 200. For example, as shown in FIG. 2, one or more cloud scanners 270 may be distributed at a location in communication with the remote network 260, wherein the term “remote network” as used herein may refer to the Internet, a partner network, a wide area network, a cloud infrastructure, and/or any other suitable external network. As such, the terms “remote network,” “external network,” “partner network,” and “Internet” may all be used interchangeably to suitably refer to one or more networks other than the networks 100, 200 that are managed using the vulnerability management systems 150, 250, while references to “the network” and/or “the internal network” may generally refer to the areas that the systems and methods described herein may be used to protect or otherwise manage. Accordingly, in one implementation, limiting the portions in the managed network 200 and/or the remote network 260 that the active scanners 210 are configured to interrogate, probe, or otherwise scan and having the active scanners 210 perform the scans in parallel may reduce the amount of time that the active scans consume because the active scanners 210 can be distributed closer to scanning targets. In particular, because the active scanners 210 may scan limited portions of the network 200 and/or offload scanning responsibility to the cloud scanners 270, and because the parallel active scans may obtain information from the different portions of the network 200, the overall amount of time that the active scans consume may substantially correspond to the amount of time associated with one active scan.

As such, in one implementation, the active scanners 210 and/or cloud scanners 270 may generally scan the respective portions of the network 200 to obtain information describing vulnerabilities and assets in the respective portions of the network 200. In particular, the active scanners 210 and/or cloud scanners 270 may perform the credentialed and/or uncredentialed scans in the network in a scheduled or distributed manner to perform patch audits, web application tests, operating system configuration audits, database configuration audits, sensitive file or content searches, or other active probes to obtain information describing the network. For example, the active scanners 210 and/or cloud scanners 270 may conduct the active probes to obtain a snapshot that describes assets actively running in the network 200 at a particular point in time (e.g., actively running network devices 240, internal firewalls 280, external firewalls 284, and/or other assets 230). In various embodiments, the snapshot may further include any exposures that the actively running assets to vulnerabilities identified in the network 200 (e.g., sensitive data that the assets contain, intrusion events, anomalies, or access control violations associated with the assets, etc.), configurations for the actively running assets (e.g., operating systems that the assets run, whether passwords for users associated with the assets comply with certain policies, whether assets that contain sensitive data such as credit card information comply with the policies and/or industry best practices, etc.), or any other information suitably describing vulnerabilities and assets actively detected in the network 200. In one implementation, in response to obtaining the snapshot of the network 200, the active scanners 210 and/or cloud scanners 270 may then report the information describing the snapshot to the vulnerability management system 250, which may use the information provided by the active scanners 210 to remediate and otherwise manage the vulnerabilities and assets in the network.

Furthermore, in one implementation, the passive scanners 220 may be distributed at various locations in the network 200 to monitor traffic traveling across the network 200, traffic originating within the network 200 and directed to the remote network 260, and traffic originating from the remote network 260 and directed to the network 200, thereby supplementing the information obtained with the active scanners 210. For example, in one implementation, the passive scanners 220 may monitor the traffic traveling across the network 200 and the traffic originating from and/or directed to the remote network 260 to identify vulnerabilities, assets, or information that the active scanners 210 may be unable to obtain because the traffic may be associated with previously inactive assets that later participate in sessions on the network. Additionally, in one implementation, the passive scanners 220 may be deployed directly within or adjacent to an intrusion detection system sensor 215, which may provide the passive scanners 220 with visibility relating to intrusion events or other security exceptions that the intrusion detection system (IDS) sensor 215 identifies. In one implementation, the IDS may be an open source network intrusion prevention and detection system (e.g., Snort), a packet analyzer, or any other system that having a suitable IDS sensor 215 that can detect and prevent intrusion or other security events in the network 200.

Accordingly, in various embodiments, the passive scanners 220 may sniff one or more packets or other messages in the traffic traveling across, originating from, or directed to the network 200 to identify new network devices 240, internal firewalls 280, external firewalls 284, or other assets 230 in addition to open ports, client/server applications, any vulnerabilities, or other activity associated therewith. In addition, the passive scanners 220 may further monitor the packets in the traffic to obtain information describing activity associated with web sessions, Domain Name System (DNS) sessions, Server Message Block (SMB) sessions, File Transfer Protocol (FTP) sessions, Network File System (NFS) sessions, file access events, file sharing events, or other suitable activity that occurs in the network 200. In one implementation, the information that the passive scanners 220 obtains from sniffing the traffic traveling across, originating from, or directed to the network 200 may therefore provide a real-time record describing the activity that occurs in the network 200. Accordingly, in one implementation, the passive scanners 220 may behave like a security motion detector on the network 200, mapping and monitoring any vulnerabilities, assets, services, applications, sensitive data, and other information that newly appear or change in the network 200. The passive scanners 220 may then report the information obtained from the traffic monitored in the network to the vulnerability management system 250, which may use the information provided by the passive scanners 220 in combination with the information provided from the active scanners 210 to remediate and otherwise manage the network 200.

In one implementation, as noted above, the network 200 shown in FIG. 2 may further include a log correlation engine 290, which may receive logs containing one or more events from various sources distributed across the network 200 (e.g., logs describing activities that occur in the network 200, such as operating system events, file modification events, USB device insertion events, etc.). In particular, the logs received at the log correlation engine 290 may include events generated by one or more of the internal firewalls 280, external firewalls 284, network devices 240, and/or other assets 230 in the network 200 in addition to events generated by one or more operating systems, applications, and/or other suitable sources in the network 200. In one implementation, the log correlation engine 290 may normalize the events contained in the various logs received from the sources distributed across the network 200, and in one implementation, may further aggregate the normalized events with information describing the snapshot of the network 200 obtained by the active scanners 210 and/or the network traffic observed by the passive scanners 220. Accordingly, in one implementation, the log correlation engine 290 may analyze and correlate the events contained in the logs, the information describing the observed network traffic, and/or the information describing the snapshot of the network 200 to automatically detect statistical anomalies, correlate intrusion events or other events with the vulnerabilities and assets in the network 200, search the correlated event data for information meeting certain criteria, or otherwise manage vulnerabilities and assets in the network 200.

Furthermore, in one implementation, the log correlation engine 290 may filter the events contained in the logs, the information describing the observed network traffic, and/or the information describing the snapshot of the network 200 to limit the information that the log correlation engine 290 normalizes, analyzes, and correlates to information relevant to a certain security posture (e.g., rather than processing thousands or millions of events generated across the network 200, which could take a substantial amount of time, the log correlation engine 290 may identify subsets of the events that relate to particular intrusion events, attacker network addresses, assets having vulnerabilities that the intrusion events and/or the attacker network addresses target, etc.). Alternatively (or additionally), the log correlation engine 290 may persistently save the events contained in all of the logs to comply with regulatory requirements providing that all logs must be stored for a certain period of time (e.g., saving the events in all of the logs to comply with the regulatory requirements while only normalizing, analyzing, and correlating the events in a subset of the logs that relate to a certain security posture). As such, the log correlation engine 290 may aggregate, normalize, analyze, and correlate information received in various event logs, snapshots obtained by the active scanners 210 and/or cloud scanners 270, and/or the activity observed by the passive scanners 220 to comprehensively monitor, remediate, and otherwise manage the vulnerabilities and assets in the network 200. Additionally, in one implementation, the log correlation engine 290 may be configured to report information relating to the information received and analyzed therein to the vulnerability management system 250, which may use the information provided by the log correlation engine 290 in combination with the information provided by the passive scanners 220, the active scanners 210, and the cloud scanners 270 to remediate or manage the network 200.

Accordingly, in various embodiments, the active scanners 210 and/or cloud scanners 270 may interrogate any suitable asset 230 in the network 200 to obtain information describing a snapshot of the network 200 at any particular point in time, the passive scanners 220 may continuously or periodically observe traffic traveling in the network 200 to identify vulnerabilities, assets, or other information that further describes the network 200, and the log correlation engine 290 may collect additional information to further identify the vulnerabilities, assets, or other information describing the network 200. The vulnerability management system 250 may therefore provide a unified solution that aggregates vulnerability and asset information obtained by the active scanners 210, the cloud scanners 270, the passive scanners 220, and the log correlation engine 290 to comprehensively manage the network 200.

Security auditing applications typically display security issues (such as vulnerabilities, security misconfigurations, weaknesses, etc.) paired with a particular solution for that given issue. Certain security issues may share a given solution, or have solutions which are superseded or otherwise rendered unnecessary by other reported solutions. Embodiments of the disclosure relate to improving an efficiency by which security issues are reported, managed and/or rectified based on solution supersedence.

In accordance with a first embodiment, when working with security reporting datasets with sparse metadata available, the reported solutions for each security issue are combined, and various “rulesets” are applied against the combined solutions to de-duplicate them and remove solutions that have been superseded by other solutions. As used herein, a ruleset is a set of rules that govern when a solution is to be removed or merged with another and how that merge is to be accomplished. In an example, when solution texts not matching a given ruleset are discovered they are flagged for manual review. Examples of rules that may be included in one or more rulesets are as follows:
If there is more than one matching solution in the solution list, remove all but one of those solutions.
For solutions matching “Upgrade to <product> x.y.z” where x, y, and z are integers, select a single result with the highest x.y.z value (comparing against x first, then y, then z).
For solutions matching “Apply fix <fix> to <product>”, create a new combined solution where <fix> for each solution is concatenated into a comma separated list for a given <product>.

In accordance with a second embodiment, when working with datasets with metadata available that have an identifier that allows grouping of solutions based on product (e.g., common product enumeration (CPE)) and timestamp information on when a fix has become available, the solutions for each group can be filtered with only display the latest “top level” solution for each group being displayed. In an example, the first and second embodiments can be implemented in conjunction with each other to produce a further refined solution set.

As used herein, a “plug-in” contains logic and metadata for an individual security check in a security auditing application. A plugin may check for one or more mitigations/fixes and flag one or more individual security issues. CPE is a standardized protocol of describing and identifying classes of applications, operating systems, and hardware devices present among an enterprise's computing assets. CPE identifiers contain asset type information (OS/Hardware/Application), vendor, product, and can even contain version information. An example CPE string is “cpe:/o: microsoft: windows_vista: 6.0: sp1”, where “/o” stands for operating system, Microsoft is the vendor, windows_vista is the product, major version is 6.0, and minor version is SP1. Further, a common vulnerabilities and exposures (CVE) identifier is an identifier from a national database maintained by NIST/Mitre which keeps a list of known vulnerabilities and exposures. An example identifier would be “CVE-2014-6271” which corresponds to the “ShellShock” vulnerability in the database.

In accordance with one implementation of the second embodiment, solutions (or solution ‘texts’) may first together based on the CPEs in the plugins they were reported in. The solutions are then sorted by the patch publication date from the plugins which they were sourced from. Solutions containing text that matches a pattern that indicates that the solution is likely a patch recommendation can all be removed from the group except the solution associated with the most recent patch. In this manner, patches with identifiers that cannot be easily sorted (e.g., patches with non-numerical identifiers) and/or for which no ruleset pertains in accordance with the first embodiment can be filtered out from the solution set. In some implementations, additional ruleset-based filtering from the first embodiment can also be applied, to filter out (or de-duplicate) additional duplicate solution information.

In accordance with a third embodiment, a security auditing application may evaluate further metadata in the solution report results that is added based upon asset-specific information (e.g., such as individual patches installed, which mitigations and patches are missing, what individual software installations are installed, patch supersedence information, the relationship between the mitigations/patches and security issues, etc.).

Web applications can be an essential way to conduct business. Unfortunately, web applications can also be vulnerable to attacks (e.g., denial of service, disclosure of private information, network infiltration, etc.) due to their exposure to public internet. Thus, addressing vulnerabilities before an attacker can exploit them is a high priority. Web application scanning (WAS) can be performed to identify vulnerabilities associated with web applications. For example, a web application scanner (or simply “scanner”) may be used to scan externally accessible website page for vulnerable web applications.

WAS scans may take a relatively long time to perform, and many scans of redundant web pages or substantially redundant web pages may be performed. For example, a newly scanned web page may include only altered content (e.g., text, images, video, etc.) without any functional alterations, making that scan redundant.

When crawling a web application, a large number of web pages are discovered. Hence, deciding which of these web pages to audit via a security audit scan, and which will provide little to no benefit in auditing via the security audit scan, may help to reduce WAS scan times.

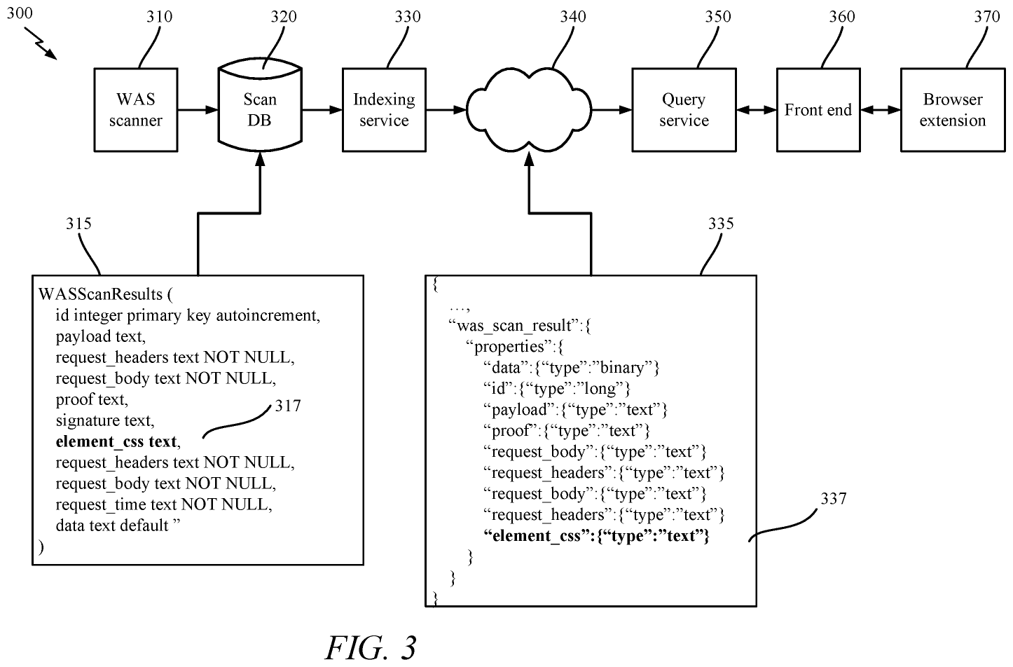

According to various aspects, FIG. 3 illustrates a diagram of an example system 300 suitable for interactive remediation of vulnerabilities of web applications based on scanning of web applications. In particular, as shown in FIG. 3, the system 300 may include a WAS scanner (or simply “scanner”) 310, a scan results 320 (e.g., a database (DB)), a first cloud service 330, a search engine 340, a second cloud service 350, a front end 360, and a browser extension 370. The first and second cloud services 330, 350 may be a same cloud service or different cloud services.

Generally, the scanner 310 may include an element selector for the vulnerable element as a part of its result placed into the scan results 320. Examples (not necessarily exhaustive) of an element selector may include CSS selector, XPath selector, Node number selector, Name selector, Id selector, LinkText selector, and so on. This information may then be passed into the search engine 340 by the first cloud service 330 and included in results from the second cloud service 350 when queried for data about specific vulnerabilities, e.g., from the front end 360. If an element selector exists, the front end 360 (e.g., browser) may include a button that links back to the vulnerable URL and element.

The scanner 310 may be configured to scan web pages to identify one or more vulnerabilities of web applications, i.e., vulnerabilities of elements in web pages. In particular, the scanner 310 may include a selector (not shown) for the vulnerable element in the scan results 320. For example, the selector may implement a scanner function (selector create function) that will take the current element and produce an element selector from it. The URL the element appears on may be included as separate data. A final test may be run before including the data to ensure that the element can be gotten to or otherwise accessible without any extra browser steps that the system is unaware of. Such data may be kept in a table in the scan results 320. For example, a FIG. 3 illustrates a VulnerabilitiesDetected table 315, which includes a field for an element selector 317 denoted as “element_css”, which is of text type.

The first cloud service 330 may be configured to index the search results within scan results 320. In particular, the first cloud service 330 may be configured to ensure that the field for the element selector 317 is included when the search engine 340 performs a search. In FIG. 3, it is seen the “was_scan_results” 335 data includes the element selector data 337, which is denoted as “element_css”: {“type”: “text”}.

The second cloud service 350 may be configured to query the search engine 340 for results of WAS scanning, e.g., performed by the scanner 310. In particular, the second cloud service 350 may be configured to query the search engine 340 for the element selector data 337. For example, the second cloud service 350 may submit the following query to pick up the element selector data 337 and return its response, e.g., to the front end 360.
GET/scans/{scanId}/hosts/{hostId}/plugins/{pluginId}

The front end 360 may be configured to receive the WAS scanning results data, including the element selector data for the vulnerable elements. The front end 360 may also be configured to include a button or some other visible element, which when activated (e.g., pressed by a user) will pass message to the browser extension 370 (e.g., chrome extension). The front end 360 may pass at least the following data in the message to the browser extension 370:
URL
Element selector
Plugin ID

The browser extension 370 may be configured to take the message passed from the front end 360, open the URL, and highlight and snap to the vulnerable element. In an aspect, the browser extension 370 may open the URL in a new tab of the browser.

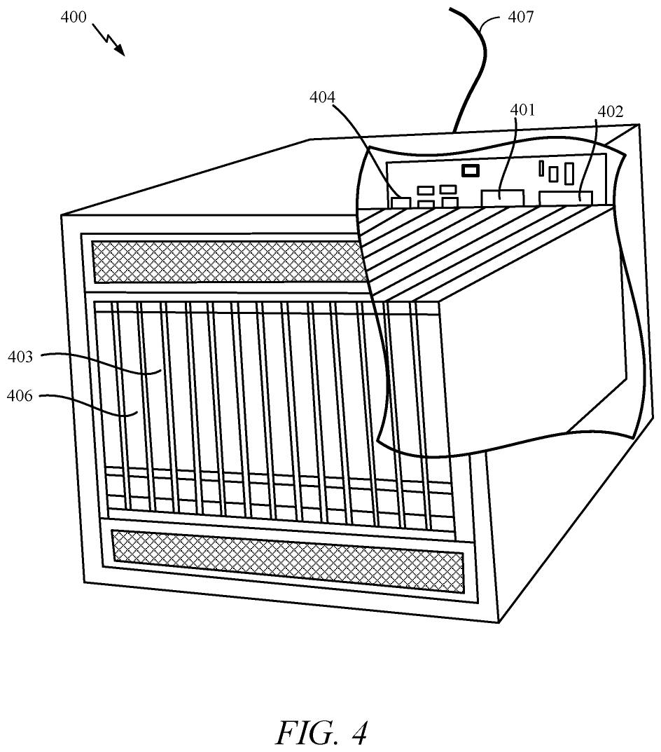

The various embodiments may be implemented on any of a variety of commercially available server devices, such as server 400 illustrated in FIG. 4. In an example, the server 400 may correspond to one example configuration of a server on which a security auditing application may execute, which in certain implementations may be included as part of the vulnerability management system 150 of FIG. 1 or the vulnerability management system 250 of FIG. 2 or WAS scanner 300 of FIG. 3. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet.

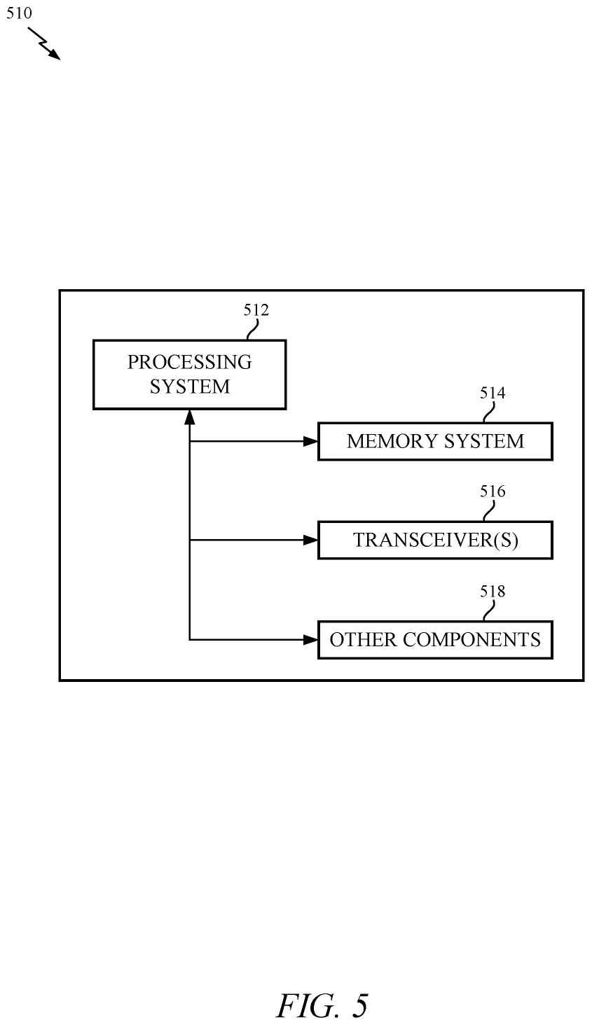

While FIG. 4 illustrates an example whereby a server-type apparatus 400 may implement various processes of the disclosure, in other aspects various aspects of the disclosure may execute on a user equipment (UE), such as UE 510 depicted in FIG. 5.

FIG. 5 generally illustrates a UE 510 in accordance with aspects of the disclosure. In some designs, UE 510 may correspond to any UE-type that is capable of executing the process(es) in accordance with aspects of the disclosure, including but not limited to a mobile phone or tablet computer, a laptop computer, a desktop computer, a wearable device (e.g., smart watch, etc.), and so on. The UE 510 depicted in FIG. 5 includes a processing system 512, a memory system 514, and at least one transceiver 516. The UE 510 may optionally include other components 518 (e.g., a graphics card, various communication ports, etc.).

Every modern organization uses software to view, manage and edit their employees' data. Parts of this data may be shared with third party organizations to provide various services such as threat, misconfiguration or vulnerability detection.

The number of misconfiguration or vulnerability results generated from such services is often overwhelming for the company receiving it; and in many cases, it takes too much time to find and address relevant findings before it is too late. Thus, there are various ideas to prioritize presented findings. For example, in vulnerability detection products, vulnerabilities are typically prioritized by vulnerability severity. This is usually straightforward, as when a vulnerability is discovered, that vulnerability is assigned a severity score.

However, in terms of company risk exposure, vulnerability severity is only one relevant parameter. Another relevant parameter relates to the owner of the asset with a vulnerability. For example, a compromised asset operated by a janitor employed by a company will generally be associated with less strategic risk to the company than a comprised asset operated by a chief executive officer (CEO) of the company. Automating an allocation of job criticality to digital identifies is difficult for various reasons, such as disparities in title names between companies, disparities in job responsibilities associated with the same/similar titles between companies, and so on.

Aspects of the disclosure are directed to determination of job criticality based on a role associated with the digital identity, a title associated with the digital identity, a set of titles that are analogous to the title associated with the digital identity, and a management structure associated with the digital identity. Such aspects may provide various technical advantages, such as automatic assignment of job criticality to digital identities, which may save significant time as compared to a manual assignment of job criticality to digital identities. Once determined, the job criticality may factor into one or more security functions.

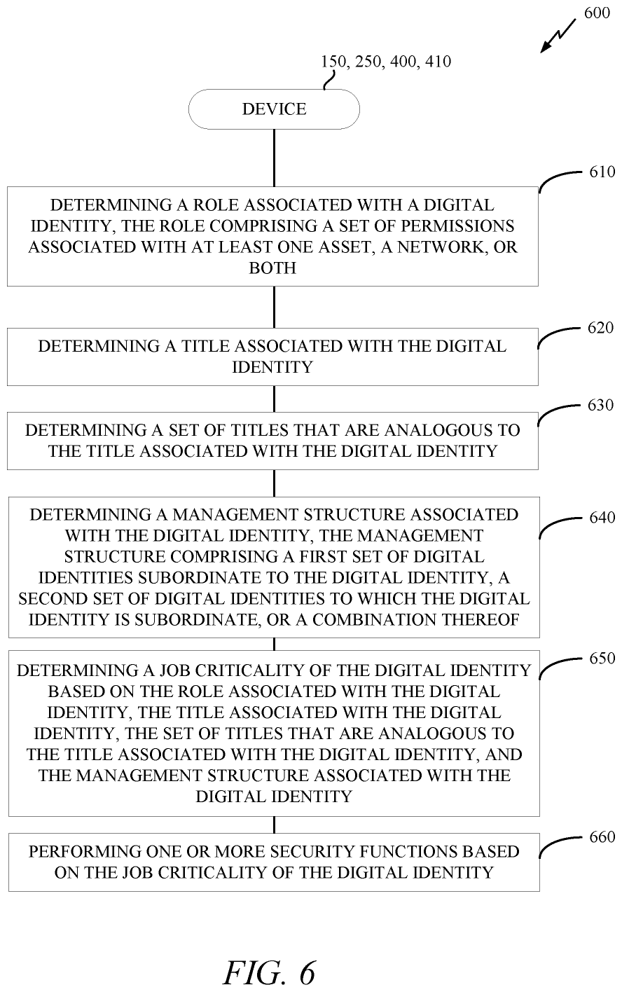

FIG. 6 illustrates a process 600, in accordance with aspects of the disclosure. The process 600 of FIG. 6 may be performed by a component, such as vulnerability management system 150, vulnerability management system 250, server 400 or UE 510.

Referring to FIG. 6, at 610, the component (e.g., processor(s) 401, processing system 512, etc.) determines a role associated with a digital identity, the role comprising a set of permissions associated with at least one asset, a network, or both. In an aspect, the role and its associated permissions may be provided to the component from an administrator of the asset(s) and/or network associated with the digital identity.

Referring to FIG. 6, at 620, the component (e.g., processor(s) 401, processing system 512, etc.) determines a title associated with the digital identity. In an aspect, the title may be provided to the component from an administrator of the asset(s) and/or network associated with the digital identity.

Referring to FIG. 6, at 630, the component (e.g., processor(s) 401, processing system 512, etc.) determines a set of titles that are analogous to the title associated with the digital identity. In an aspect, the set of titles may be retrieved from a title lookup table (e.g., which may be manually configured in advance).

Referring to FIG. 6, at 640, the component (e.g., processor(s) 401, processing system 512, etc.) determines a management structure associated with the digital identity, the management structure comprising a first set of digital identities subordinate to the digital identity, a second set of digital identities to which the digital identity is subordinate, or a combination thereof. In an aspect, the management structure (e.g., an organization chart, etc.) may be provided to the component from an administrator of the asset(s) and/or network associated with the digital identity.

Referring to FIG. 6, at 650, the component (e.g., processor(s) 401, processing system 512, etc.) determines a job criticality of the digital identity based on the role associated with the digital identity, the title associated with the digital identity, the set of titles that are analogous to the title associated with the digital identity, and the management structure associated with the digital identity. Examples of the determination of 650 will be described below in more detail.

Referring to FIG. 6, at 660, the component (e.g., processor(s) 401, processing system 512, etc.) performs one or more security functions based on the job criticality of the digital identity.

Referring to FIG. 6, in some designs, the determination at 650 of the job criticality of the digital identity comprises: determining a set of scores associated with the set of permissions, and deriving a role score based on the set of scores. In an aspect, the job criticality of the digital identity is a function of the role score.

Referring to FIG. 6, in some designs, the determination at 650 of the job criticality of the digital identity comprises: generating the set of titles that are that are analogous to the title associated with the digital identity using a machine-learning (ML) model; tokenizing each title in the set of titles via a natural language processing (NPL) model to produce a set of token scores associated with each extracted token. In an aspect, the deriving of the title score for the title associated with the digital identity is based on a weighting of each title score of the set of title scores is that is based on a similarity confidence level between the title associated with the digital identity and the respective title from the set of titles. In an aspect, the tokenizing comprises extracting, from each title in the set of titles, one or more responsibility tokens, one or more function tokens, one or more scope tokens, or any combination thereof, and assigning each extracted token a respective token score. In an aspect, the ML model comprises a neutral network (NN).

Referring to FIG. 6, in some designs, the determination at 650 of the job criticality of the digital identity comprises: deriving a management score for the digital identity based on a number of digital identities in the first set of digital identities, the second set of digital identities, or both, wherein the job criticality of the digital identity is a function of the management score.

Referring to FIG. 6, in some designs, the job criticality of the digital identity is based on: a role score that is based on the role associated with the digital identity, a title score that is based on the title associated with the digital identity, and a management score that is based on the management structure associated with the digital identity.

Referring to FIG. 6, in some designs, the role associated with the digital identity is defined in accordance with a role based access control (RBAC) system.

Referring to FIG. 6, in some designs, the title is input as a string and the job criticality is output as a numeric value or a numeric label.

Machine learning may be used to generate models that may be used to facilitate various aspects associated with processing of data. One specific application of machine learning relates to generation of measurement models for processing of reference signals for positioning (e.g., positioning reference signal (PRS)), such as feature extraction, reporting of reference signal measurements (e.g., selecting which extracted features to report), and so on.

Machine learning models are generally categorized as either supervised or unsupervised. A supervised model may further be sub-categorized as either a regression or classification model. Supervised learning involves learning a function that maps an input to an output based on example input-output pairs. For example, given a training dataset with two variables of age (input) and height (output), a supervised learning model could be generated to predict the height of a person based on their age. In regression models, the output is continuous. One example of a regression model is a linear regression, which simply attempts to find a line that best fits the data. Extensions of linear regression include multiple linear regression (e.g., finding a plane of best fit) and polynomial regression (e.g., finding a curve of best fit).

Another example of a machine learning model is a decision tree model. In a decision tree model, a tree structure is defined with a plurality of nodes. Decisions are used to move from a root node at the top of the decision tree to a leaf node at the bottom of the decision tree (i.e., a node with no further child nodes). Generally, a higher number of nodes in the decision tree model is correlated with higher decision accuracy.

Another example of a machine learning model is a decision forest. Random forests are an ensemble learning technique that builds off of decision trees. Random forests involve creating multiple decision trees using bootstrapped datasets of the original data and randomly selecting a subset of variables at each step of the decision tree. The model then selects the mode of all of the predictions of each decision tree. By relying on a “majority wins” model, the risk of error from an individual tree is reduced.

Another example of a machine learning model is a neural network (NN). A neural network is essentially a network of mathematical equations. Neural networks accept one or more input variables, and by going through a network of equations, result in one or more output variables. Put another way, a neural network takes in a vector of inputs and returns a vector of outputs.

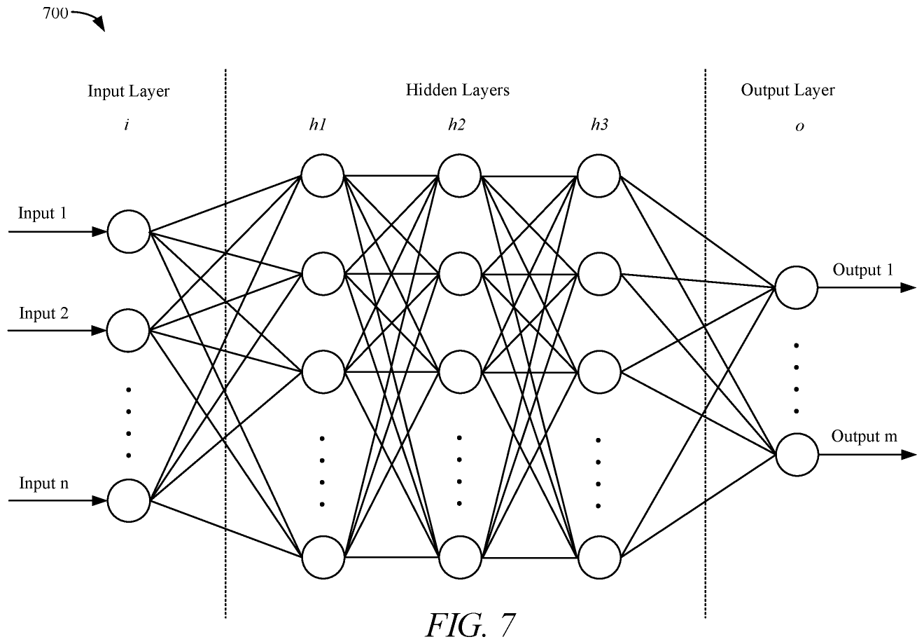

FIG. 7 illustrates an example neural network 700, according to aspects of the disclosure. The neural network 700 includes an input layer ‘i’ that receives ‘n’ (one or more) inputs (illustrated as “Input 1,” “Input 2,” and “Input n”), one or more hidden layers (illustrated as hidden layers ‘h1,’ ‘h2,’ and ‘h3’) for processing the inputs from the input layer, and an output layer ‘o’ that provides ‘m’ (one or more) outputs (labeled “Output 1” and “Output m”). The number of inputs ‘n,’ hidden layers ‘h,’ and outputs ‘m’ may be the same or different. In some designs, the hidden layers ‘h’ may include linear function(s) and/or activation function(s) that the nodes (illustrated as circles) of each successive hidden layer process from the nodes of the previous hidden layer.

In classification models, the output is discrete. One example of a classification model is logistic regression. Logistic regression is similar to linear regression but is used to model the probability of a finite number of outcomes, typically two. In essence, a logistic equation is created in such a way that the output values can only be between ‘0’ and ‘1.’ Another example of a classification model is a support vector machine. For example, for two classes of data, a support vector machine will find a hyperplane or a boundary between the two classes of data that maximizes the margin between the two classes. There are many planes that can separate the two classes, but only one plane can maximize the margin or distance between the classes. Another example of a classification model is Naïve Bayes, which is based on Bayes Theorem. Other examples of classification models include decision tree, random forest, and neural network, similar to the examples described above except that the output is discrete rather than continuous.

Unlike supervised learning, unsupervised learning is used to draw inferences and find patterns from input data without references to labeled outcomes. Two examples of unsupervised learning models include clustering and dimensionality reduction.

Clustering is an unsupervised technique that involves the grouping, or clustering, of data points. Clustering is frequently used for customer segmentation, fraud detection, and document classification. Common clustering techniques include k-means clustering, hierarchical clustering, mean shift clustering, and density-based clustering. Dimensionality reduction is the process of reducing the number of random variables under consideration by obtaining a set of principal variables. In simpler terms, dimensionality reduction is the process of reducing the dimension of a feature set (in even simpler terms, reducing the number of features). Most dimensionality reduction techniques can be categorized as either feature elimination or feature extraction. One example of dimensionality reduction is called principal component analysis (PCA). In the simplest sense. PCA involves project higher dimensional data (e.g., three dimensions) to a smaller space (e.g., two dimensions). This results in a lower dimension of data (e.g., two dimensions instead of three dimensions) while keeping all original variables in the model.

Regardless of which machine learning model is used, at a high-level, a machine learning module (e.g., implemented by a processing system) may be configured to iteratively analyze training input data (e.g., measurements of reference signals to/from various target UEs) and to associate this training input data with an output data set (e.g., a set of possible or likely candidate locations of the various target UEs), thereby enabling later determination of the same output data set when presented with similar input data (e.g., from other target UEs at the same or similar location).

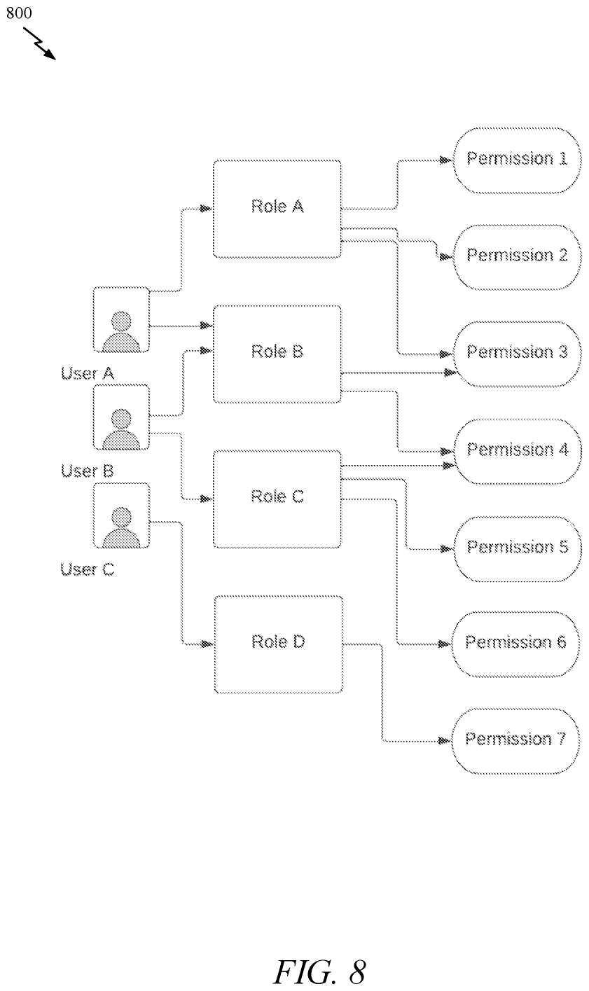

Referring to FIG. 6, a first example implementation will now be described in the following paragraphs with respect to FIGS. 8-10. In particular, given very limited information such as a job title for a given identity, the example implementation described below is able to establish associated job functions, responsibilities as well as their scope. This serves as a base associating aggregate scores with given job titles. This is then refined based on the organization hierarchy structure and entitlements associated with the provided identity. Such aspects will work well when given only partial information from the above variables, as well as with previously unseen job titles. Such aspects may work well in detecting the most critical users in a given organization as well as the least critical ones. This can be used not only for ranking but also for finding anomalies, e.g., discovering the least critical users that are over-privileged and have too broad access to organization's resources based on their work roles and functions. Such aspects may also use the generated findings as the input for other tools, e.g., to find hidden paths to critical identities from other company individuals or resources.

In the first example implementation, for convenience of explanation, the amount of required data for each digital identity is limited to: 1) business title; 2) the number of direct reports and the manager name; 3) assigned roles and permissions. Results for (1)-(3) are combined to provide calculated identity criticality scores. Results will be provided if any of the components is present; however, the more parameters are provided, the more accurate results will be.

The first example implementation is designed with Role Based Access Control (RBAC) systems. In such a scenario a user is given roles and each role consists of a number of permissions. An example for three users is depicted in FIG. 8 with respect to a simple RBAC structure 800.

In the first example implementation, it is assumed that certain roles are considered key and should be restricted to certain users only. Typically, roles could require multi-factor authentication. Permissions that are exclusively associated with them should be considered more valuable; then permissions associated with both key and non-key roles should be considered of medium importance; while the permissions associated with the remaining roles may be ignored. Then, each role can be evaluated by using these results. This can be represented with the following Procedures:

Procedure 1: Establish Permission Importance

```
Input:
  Rk = {rk1, ... , rkn}; key roles
  R = {r1, ... , rn}; all roles
Output: Pk: {p1, ..., pn}, P: {p1, pn}; two sets of key importance permissions and
medium importance permissions
all_permissions = set( )
key_permissions = set( )
for r in R do:
  for p in r do:
    all_permissions.add(p)
for r in Rk do:
  for p in r do:
    key_permissions.add(p)
return key_permissions distinct all_permissions, key_permissions intersection
all_permissions
```

Procedure 2: Establish Role importance

```
Input:
  R: role to be evaluated
  Pk: the set of key important permissions
  P: the set of medium importance permissions
Output: Score; calculated score for a role
score = 0
for p in R do:
  If p in Pk:
    score = score + 10
  else If p in P:
    score = score + 1
return score
```

If it is assumed that in FIG. 8 that the key roles are Role C and Role D, the computations are as follows:
Role C contains Permission 4, 5, 6; and Role D contains only Permission 7. Permission 4 is shared by Role C and Role B. Thus, Procedure 1 would evaluate that Permission 5, 6 and 7 are the key ones; Permission 4 is of medium importance and the remaining ones are unimportant.
Then, Procedure 2, would use these values to calculate the following values for roles importance:
Role A=importance of permissions 1, 2, 3=0 Role B=importance of permissions 3, 4=1 Role C=importance of permissions 4, 5, 6=21 Role D=importance of permissions 7=10
Therefore, Role A that has three permissions is evaluated as less important than Role D that has only one permission because of their underlying importance. Thus User B would have increased criticality as he has increased access within the analyzed organization.

Next in the first example implementation, user business titles are evaluated. Employees business titles have relevant implicit value that is often omitted. For example, it is possible to infer various functions, roles and responsibilities or scope from a business title.

The following titles can be processed by using Natural Language Processing (NLP) approaches and tokenized in the following way:
senior software engineer:
   1. Senior: responsibility
   2. Software: function
   3. Engineer: responsibility
vice-president of Marketing (Europe)
   1. Vice-president: responsibility
   2. Marketing: function
   3. Europe: scope
contingent worker
   1. Contingent: responsibility
   2. Worker: responsibility (same token but two words)

Applying this method, it is possible to extract certain information and get some approximation of the number of responsibilities, functions and their scope just from the job title. This can be also applied to job descriptions to extract additional information.

In the first example implementation, the next step is to provide scores for each extracted token. For example, 1 point may be allocated for responsibility and function and 2 points may be allocated for location.

In the example above the scores would be the following:
senior software engineer: 3
contingent worker: 1
vice-president of Marketing (Europe): 4

In some designs, a problem may occur whereby various organizations have different naming conventions and senior engineer can be called staff engineer or principal engineer or software engineer and so on. To address these problems to evaluate a job title, in addition to score calculation, a neural network may be utilized to get the N closest titles and their scores. In an aspect, a sentence transformer architecture and processing is explained with respect to Procedure 3, e.g.:

Procedure 3: Calculate job title ranking

```
Input: title: string
Output: score: float
  Let embeddings: hash map of job title to its n-dimensional processed
representation
  Let jobtitle_scores: hash map of job title to its score
  title_vector = model.encode(title); encode title to an n-dimensional vector
  similarity_scores = calc_distacnces(embeddings, title_vector)
  sim_ind = getIndexesOfTopNMatches(similarity_scores, 5)
  score = 0
  for i in sim_ind:
    score = score + jobtitle_scores[i.job_title]
    score = score / size(sim_ind)
  return score
```

For calc_distances, a function such as util.dot_score from the numpy package may be used; and for getIndexesOfTopNMatches the argpartition function from the same package may be used.

Note that using NLP extracted tokens to associate job titles with some kind of a ranking is only one possible example implementation of the process of FIG. 6. In other designs, NLP extracted tokens may be replaced with any other formula that would assign scores to provided job titles. For example, a mapping of salary to job titles to achieve similar results; or tokens extracted from job descriptions, etc.

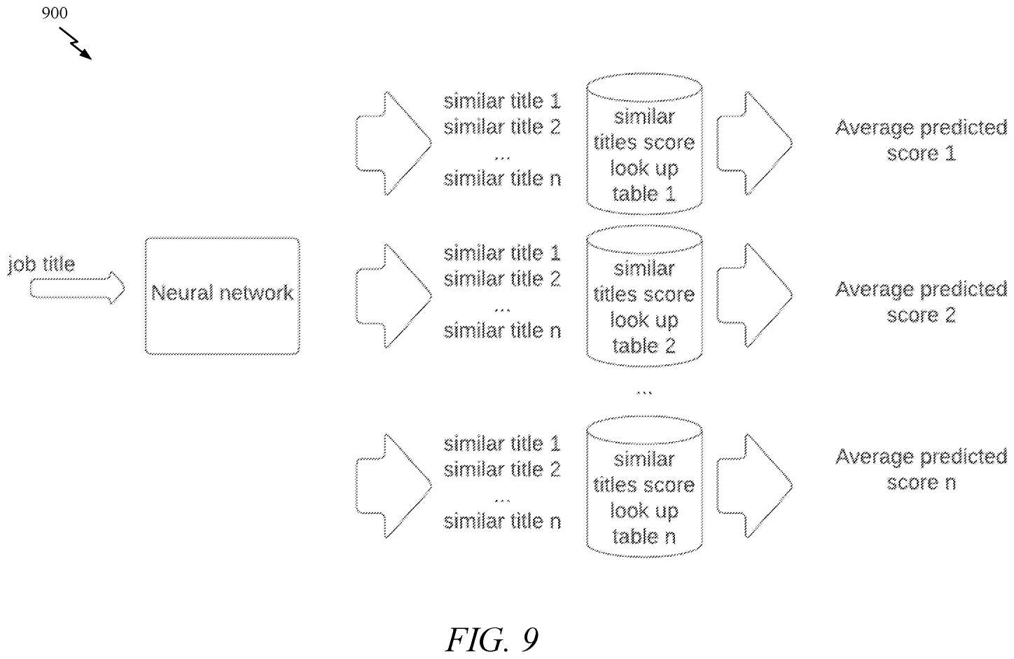

FIG. 9 illustrates the first example implementation 900 of the process of FIG. 6 in accordance with aspects of the disclosure. In particular, the first example implementation 900 as depicted in FIG. 9 shows the stages by which the job title is translated into a set of average predicted score(s) via NN-based mapping to similar titles across N title score lookup tables.

In a further example, for the input of “software engineer”, Procedure 3 may return the following pairs of results, e.g.:

TABLE 1
Title Score and Similarity Confidence

| Title | Similarity Confidence | Score |
|---|---|---|
| Principal Engineer; | 0.689 | 13 |
| Software Development and | | |
| Engineering | | |
| Engineer 3; Software | 0.735 | 10 |
| Development and | | |
| Engineering | | |
| Software Engineer I at | 0.775 | 7 |
| Company X | | |
| Software Development and | 0.810 | 7 |
| Engineering | | |
| Software Developer | 0.767 | 4 |

In some designs, similarity confidence results are produced by neural networks. In some designs, the average of results may be taken from titles with a certain similarity confidence only (e.g., above some similarity threshold). If all the results based on Table 1 are averaged, the produced score would be 8.2 (average of: 13, 10, 7, 7, 4).

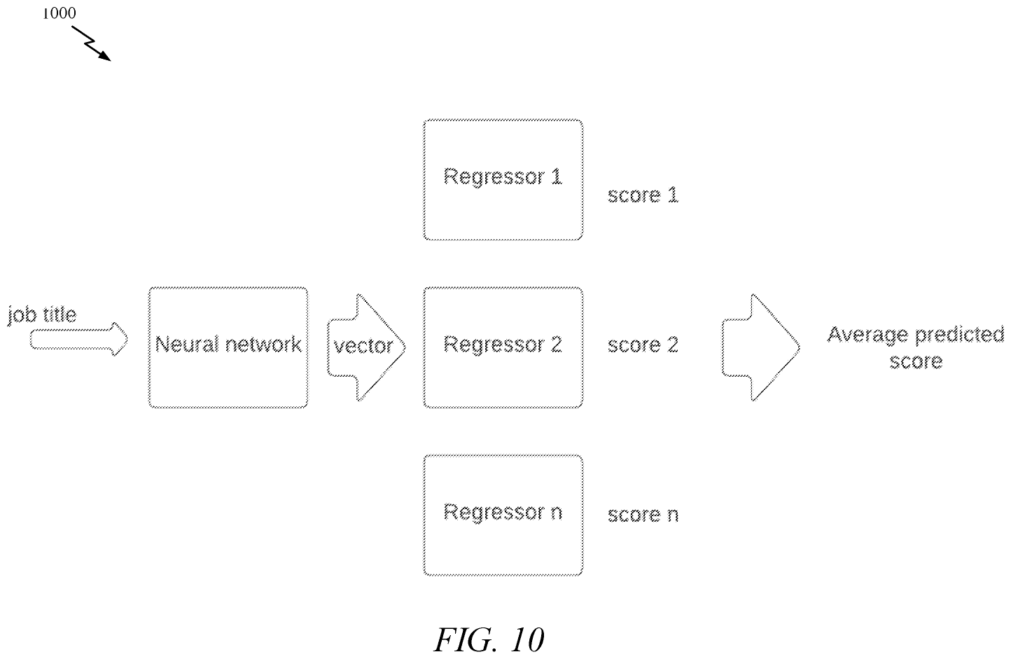

Please note that the obtained sentence vector representation may also be passed through a regressor component, such as linear regression, support vector regression (SVR), or neural networks (e.g., see FIG. 10) and then obtain a similar score. However, results from the first example implementation show that this was less performant, especially for previously unseen job titles. FIG. 10 illustrates the first example implementation 1000 of the process of FIG. 6 in accordance with aspects of the disclosure. In particular, the first example implementation 1000 as depicted in FIG. 10 shows the stages by which the job title is translated into an average predicted score(s) via NN-based mapping to a vector that is applied to N regressors to produce N scores, which are then averaged. Referring to FIG. 10, the applied neural network uses the sentence transformer architecture, i.e., for a given input text, it will provide its vector representation.

Next, still referring to the first example implementation of the process of FIG. 6, the calculation of a user's “neighborhood” in the management structure is evaluated. Even with the same job titles, employees can have different criticality for their organization. An administrative assistant of the CEO in any company, may be more critical than any other person with such a title in this company. Similarly, if there are two managers at the same level in an organization but they significantly differ with the number of direct reports, the one who has more (or more critical direct reports) should be considered more critical to the business. In some designs, taking into account the entire organization structure may be computationally intensive and not necessarily needed. In an aspect, only the nearest neighborhood of each identity and their scores from the previous step may be factored into Procedure 4 for the calculation of a hierarchy score (or management structure score), e.g.:

Procedure 4: Calculate hierarchy score

```
Input: user_id: string
Output: score: float
user_id_job_title_scores: hashmap
user_id_manager_id: hashmap
score := 0
score = user_id_job_title_scores[user_id.manager_id] * 0.25
for key, value in user_id_manager_id do
  If value == user_id:
    Score = score + user_id_job_title_scores[key] * 0.15
return score
```

Via Procedure 4, the number of required database operations and are limited and a large portion of results may be pre-computed.

Next, still referring to the first example implementation of the process of FIG. 6, the aggregate score is calculated.

In an aspect, the aggregate score (Icr) is calculated as a multiplication of normalized values of its various components, e.g.,

$$Icr = Jtcr * Hcr * Ecr$$

where:
Ecr is normalized to the range of 1 (default roles and permissions) and 2 (high amount of key roles and permissions),
Hcr is a score for a user that is a sum of fractional manager score and fractions of direct reports, and
Jter is a score that is inferred from provided job title.

Under these assumptions, Table 2 depicts an example of these values:

TABLE 2

| | | Job | | | |
|---|---|---|---|---|---|
| | | Title | Hierarchy | Entitlements | Identity |
| Name | Job Title | Score | Score | Score | Criticality |
| User 1 | Software | 8 | 2.7 | 1.2 | 26.4 |
| | Engineer | | (11*0.25 = | | |
| | | | reporting to | | |
| | | | User 2, no | | |
| | | | direct | | |
| | | | reports) | | |
| User 2 | Director of | 11 | 5.8 | 1.2 | 76.56 |
| | Engineering | | (13*0.25 + | | |
| | (reporting to | | 0.15*9 + | | |
| | CTO who | | 0.15*8 = | | |
| | has job title | | reporting to | | |
| | score of 13) | | CTO and | | |
| | | | has two | | |
| | | | direct | | |
| | | | reports; | | |
| | | | User 2 and | | |
| | | | User 3) | | |
| User 3 | Senior | 9 | 3.2 | 1.2 | 34.56 |
| | Software | | (11*0.25 + | | |
| | Engineer | | 3*0.15 = | | |
| | | | reporting to | | |
| | | | User 2 and | | |
| | | | managing | | |
| | | | User 4) | | |
| User 4 | Intern | 3 | 2.25 (9 * | 1 | 6.75 |
| | | | 0.25 = | | |
| | | | reporting to | | |
| | | | User 3) | | |

In the example of Table 2, User 2 is clearly the most critical and User 4 is the least critical. Additionally, all used components: Job title score, Hierarchy score and Entitlements score rank users in a similar order; thus if one or two computation components is missing, in this particular example, the result is not significantly affected.

Referring to FIG. 6, in some designs, the set of permissions associated with at least one asset, a network, or both, comprises a set of entitlements. In an aspect, each entitlement of the set of entitlements is associated with one or more actions permitted in association with the at least one asset, the network, or both. In a further aspect, the one or more actions comprise a read action, a restricted read action, a write action, a delete action, a restore action, an enable action, a disable action, an update action, a manage action, or any combination thereof. In a further aspect, the one or more actions are each ranked in accordance with an action ranking table. In a further aspect, the component further derives, an entitlement score based on the set of entitlements, wherein the determination of the job criticality of the digital identity is based on the entitlement score.

Referring to FIG. 6, in a further aspect, the entitlement score is derived based on a neural network applied with respect to each of the one or more actions. In a further aspect, the neural network outputs an embedding for each of the one or more actions, and each embedding comprises a vector that encodes semantic information of the respective action in a mathematical space. In a further aspect, each embedding is input to a clustering algorithm that assigns each action to a cluster in a set of clusters, each cluster is associated with a particular group of similar actions, each cluster is associated with a cluster score, and each cluster score for each action is factored into the respective entitlement score.

Referring to FIG. 6, a second example implementation will now be described in the following paragraphs.

In the second example implementation, the entitlements of users within an identity provider are evaluated. An identity provider (IdP) is a service that stores and verifies user identity (e.g.: Azure AD, Okta). Entitlements are permissions assigned to a user (e.g. read a file, disable settings, update an attribute). All entitlements are associated with an action (e.g. read, disable, update) that determines what the user is able to do.

In the second example implementation, it is assumed that there is some fuzzy ordering between the actions that allow the actions to be grouped and ordered. For example, assume that, independent of context, the action write has a higher ordering than read (i.e. write>read). This is fuzzy because the relationship is not always clear, for example, manage and update are similar but neither imply a higher ordering than the other.

Given this, all actions associated with the entitlements of the identity provider may be obtained, and a neural network may be used to obtain embeddings of each action. An embedding is a vector that encodes the semantic information of the action into a mathematical space. The embeddings are then fed to a clustering algorithm that assigns each action to a cluster. These clusters are used to group similar actions together, and a score is assigned to each cluster.

In the second example implementation, the score is calculated by summing all the components of the action embeddings (obtaining a single number for each action), scaling this sum to the range [0, 1] and taking the mean of scaled scores of all actions in the cluster. Finally the cluster score is defined as 1/the mean scaled scores per cluster.

An example of the result of this clustering for actions available for Azure AD is listed in Table 3 below (note: only a subset of possible actions is shown), e.g.:

TABLE 3

| Action | Cluster ID | Score |
|---|---|---|
| read | 0 | 1.287879586 |
| restrictedRead | 0 | 1.287879586 |
| update | 1 | 1.153256774 |
| delete | 1 | 1.153256774 |
| restore | 1 | 1.153256774 |
| manage | 1 | 1.153256774 |
| enable | 2 | 1.750344396 |
| disable | 2 | 1.750344396 |

To compute the entitlement score define the Linear Component the product between the number of entitlements in cluster i (ηᵢ) and the coefficient of that cluster (βᵢ):

$$Linear Component = {\sum }_{i = 0}^{k} {β}_{i} \times {η}_{i}$$

For each user, ηᵢ is calculated by mapping the entitlements to their action and the action to its cluster, then counting the number of entitlements in each cluster. The coefficients βᵢ are computed for each customer as by dividing the cluster score by the number of entitlements in each cluster across all users for this customer. Finally, the user entitlement score for an identity provider is defined as:

$$Entitlement score = Linear Component / ( 1 + Linear Component )$$

Referring to FIG. 6, in some designs, the job criticality of the digital identity is not based on any vulnerability or exploit associated with the at least one asset, the network, or both. For example, a severely comprised asset does not increase the job criticality of the digital identity associated with (e.g., controlling/operating) that asset.

Referring to FIG. 6, in some designs, the one or more security functions comprise: allocating a job criticality-based priority to vulnerability and/or exploit remediation to one or more assets associated with the digital identity. For example, the job criticality score may be used by network administrators to prioritize assets in their remediation efforts (e.g., remediate moderate vulnerabilities for assets associated with high job criticality scores over severe vulnerabilities for assets associated with low job criticality scores, etc.).

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of operating a component, comprising: determining a role associated with a digital identity, the role comprising a set of permissions associated with at least one asset, a network, or both; determining a title associated with the digital identity; determining a set of titles that are analogous to the title associated with the digital identity; determining a management structure associated with the digital identity, the management structure comprising a first set of digital identities subordinate to the digital identity, a second set of digital identities to which the digital identity is subordinate, or a combination thereof; determining a job criticality of the digital identity based on the role associated with the digital identity, the title associated with the digital identity, the set of titles that are analogous to the title associated with the digital identity, and the management structure associated with the digital identity; and performing one or more security functions based on the job criticality of the digital identity.

Clause 2. The method of clause 1, wherein the determination of the job criticality of the digital identity comprises: determining a set of scores associated with the set of permissions; and deriving a role score based on the set of scores, wherein the job criticality of the digital identity is a function of the role score.

Clause 3. The method of any of clauses 1 to 2, wherein the determination of the job criticality of the digital identity comprises: generating the set of titles that are that are analogous to the title associated with the digital identity using a machine-learning (ML) model; tokenizing each title in the set of titles via a natural language processing (NPL) model to produce a set of token scores associated with each extracted token; deriving a set of title scores for the set of titles based on the set of token scores for the respective title; and deriving a title score for the title associated with the digital identity based on the set of title scores, wherein the job criticality of the digital identity is a function of the title score.

Clause 4. The method of clause 3, wherein the deriving of the title score for the title associated with the digital identity is based on a weighting of each title score of the set of title scores is that is based on a similarity confidence level between the title associated with the digital identity and the respective title from the set of titles.

Clause 5. The method of any of clauses 3 to 4, wherein the tokenizing comprises extracting, from each title in the set of titles, one or more responsibility tokens, one or more function tokens, one or more scope tokens, or any combination thereof, and assigning each extracted token a respective token score.

Clause 6. The method of any of clauses 3 to 5, wherein the ML model comprises a neutral network (NN).

Clause 7. The method of any of clauses 1 to 6, wherein the determination of the job criticality of the digital identity comprises: deriving a management score for the digital identity based on a number of digital identities in the first set of digital identities, the second set of digital identities, or both, wherein the job criticality of the digital identity is a function of the management score.

Clause 8. The method of any of clauses 1 to 7, wherein the job criticality of the digital identity is based on: a role score that is based on the role associated with the digital identity, a title score that is based on the title associated with the digital identity, and a management score that is based on the management structure associated with the digital identity.

Clause 9. The method of any of clauses 1 to 8, wherein the role associated with the digital identity is defined in accordance with a role based access control (RBAC) system.

Clause 10. The method of any of clauses 1 to 9, wherein the title is input as a string and the job criticality is output as a numeric value or a numeric label.

Clause 11. The method of any of clauses 1 to 10, wherein the set of permissions associated with at least one asset, a network, or both, comprises a set of entitlements.

Clause 12. The method of clause 11, wherein each entitlement of the set of entitlements is associated with one or more actions permitted in association with the at least one asset, the network, or both.

Clause 13. The method of clause 12, wherein the one or more actions comprise a read action, a restricted read action, a write action, a delete action, a restore action, an enable action, a disable action, an update action, a manage action, or any combination thereof.

Clause 14. The method of any of clauses 12 to 13, wherein the one or more actions are each ranked in accordance with an action ranking table.

Clause 15. The method of any of clauses 12 to 14, further comprising: deriving an entitlement score based on the set of entitlements, wherein the determination of the job criticality of the digital identity is based on the entitlement score.

Clause 16. The method of clause 15, wherein the entitlement score is derived based on a neural network applied with respect to each of the one or more actions.

Clause 17. The method of clause 16, wherein the neural network outputs an embedding for each of the one or more actions, wherein each embedding comprises a vector that encodes semantic information of the respective action in a mathematical space.

Clause 18. The method of clause 17, wherein each embedding is input to a clustering algorithm that assigns each action to a cluster in a set of clusters, wherein each cluster is associated with a particular group of similar actions, wherein each cluster is associated with a cluster score, and wherein each cluster score for each action is factored into the respective entitlement score.

Clause 19. The method of any of clauses 1 to 18, wherein the job criticality of the digital identity is not based on any vulnerability or exploit associated with the at least one asset, the network, or both.

Clause 20. The method of any of clauses 1 to 19, wherein the one or more security functions comprise: allocating a job criticality-based priority to vulnerability and/or exploit remediation to one or more assets associated with the digital identity.

Clause 21. A component, comprising: one or more memories; and one or more processors communicatively coupled to the one or more memories, the one or more processors, either alone or in combination, configured to: determine a role associated with a digital identity, the role comprising a set of permissions associated with at least one asset, a network, or both; determine a title associated with the digital identity; determine a set of titles that are analogous to the title associated with the digital identity; determine a management structure associated with the digital identity, the management structure comprising a first set of digital identities subordinate to the digital identity, a second set of digital identities to which the digital identity is subordinate, or a combination thereof; determine a job criticality of the digital identity based on the role associated with the digital identity, the title associated with the digital identity, the set of titles that are analogous to the title associated with the digital identity, and the management structure associated with the digital identity; and perform one or more security functions based on the job criticality of the digital identity.

Clause 22. The component of clause 21, wherein the determination of the job criticality of the digital identity comprises: determine a set of scores associated with the set of permissions; and derive a role score based on the set of scores, wherein the job criticality of the digital identity is a function of the role score.

Clause 23. The component of any of clauses 21 to 22, wherein the determination of the job criticality of the digital identity comprises: generate the set of titles that are that are analogous to the title associated with the digital identity using a machine-learning (ML) model; tokenize each title in the set of titles via a natural language processing (NPL) model to produce a set of token scores associated with each extracted token; derive a set of title scores for the set of titles based on the set of token scores for the respective title; and derive a title score for the title associated with the digital identity based on the set of title scores, wherein the job criticality of the digital identity is a function of the title score.

Clause 24. The component of clause 23, wherein the deriving of the title score for the title associated with the digital identity is based on a weighting of each title score of the set of title scores is that is based on a similarity confidence level between the title associated with the digital identity and the respective title from the set of titles.

Clause 25. The component of any of clauses 23 to 24, wherein the tokenizing comprises extracting, from each title in the set of titles, one or more responsibility tokens, one or more function tokens, one or more scope tokens, or any combination thereof, and assigning each extracted token a respective token score.

Clause 26. The component of any of clauses 23 to 25, wherein the ML model comprises a neutral network (NN).

Clause 27. The component of any of clauses 21 to 26, wherein the determination of the job criticality of the digital identity comprises: derive a management score for the digital identity based on a number of digital identities in the first set of digital identities, the second set of digital identities, or both, wherein the job criticality of the digital identity is a function of the management score.

Clause 28. The component of any of clauses 21 to 27, wherein the job criticality of the digital identity is based on: a role score that is based on the role associated with the digital identity, a title score that is based on the title associated with the digital identity, and a management score that is based on the management structure associated with the digital identity.

Clause 29. The component of any of clauses 21 to 28, wherein the role associated with the digital identity is defined in accordance with a role based access control (RBAC) system.

Clause 30. The component of any of clauses 21 to 29, wherein the title is input as a string and the job criticality is output as a numeric value or a numeric label.

Clause 31. The component of any of clauses 21 to 30, wherein the set of permissions associated with at least one asset, a network, or both, comprises a set of entitlements.

Clause 32. The component of clause 31, wherein each entitlement of the set of entitlements is associated with one or more actions permitted in association with the at least one asset, the network, or both.

Clause 33. The component of clause 32, wherein the one or more actions comprise a read action, a restricted read action, a write action, a delete action, a restore action, an enable action, a disable action, an update action, a manage action, or any combination thereof.

Clause 34. The component of any of clauses 32 to 33, wherein the one or more actions are each ranked in accordance with an action ranking table.

Clause 35. The component of any of clauses 32 to 34, wherein the one or more processors, either alone or in combination, are further configured to: derive an entitlement score based on the set of entitlements, wherein the determination of the job criticality of the digital identity is based on the entitlement score.

Clause 36. The component of clause 35, wherein the entitlement score is derived based on a neural network applied with respect to each of the one or more actions.

Clause 37. The component of clause 36, wherein the neural network outputs an embedding for each of the one or more actions, wherein each embedding comprises a vector that encodes semantic information of the respective action in a mathematical space.

Clause 38. The component of clause 37, wherein each embedding is input to a clustering algorithm that assigns each action to a cluster in a set of clusters, wherein each cluster is associated with a particular group of similar actions, wherein each cluster is associated with a cluster score, and wherein each cluster score for each action is factored into the respective entitlement score.

Clause 39. The component of any of clauses 21 to 38, wherein the job criticality of the digital identity is not based on any vulnerability or exploit associated with the at least one asset, the network, or both.

Clause 40. The component of any of clauses 21 to 39, wherein the one or more security functions comprise: allocate a job criticality-based priority to vulnerability and/or exploit remediation to one or more assets associated with the digital identity.

Clause 41. A component, comprising: means for determining a role associated with a digital identity, the role comprising a set of permissions associated with at least one asset, a network, or both; means for determining a title associated with the digital identity; means for determining a set of titles that are analogous to the title associated with the digital identity; means for determining a management structure associated with the digital identity, the management structure comprising a first set of digital identities subordinate to the digital identity, a second set of digital identities to which the digital identity is subordinate, or a combination thereof; means for determining a job criticality of the digital identity based on the role associated with the digital identity, the title associated with the digital identity, the set of titles that are analogous to the title associated with the digital identity, and the management structure associated with the digital identity; and means for performing one or more security functions based on the job criticality of the digital identity.

Clause 42. The component of clause 41, wherein the determination of the job criticality of the digital identity comprises: means for determining a set of scores associated with the set of permissions; and means for deriving a role score based on the set of scores, wherein the job criticality of the digital identity is a function of the role score.

Clause 43. The component of any of clauses 41 to 42, wherein the determination of the job criticality of the digital identity comprises: means for generating the set of titles that are that are analogous to the title associated with the digital identity using a machine-learning (ML) model; means for tokenizing each title in the set of titles via a natural language processing (NPL) model to produce a set of token scores associated with each extracted token; means for deriving a set of title scores for the set of titles based on the set of token scores for the respective title; and means for deriving a title score for the title associated with the digital identity based on the set of title scores, wherein the job criticality of the digital identity is a function of the title score.

Clause 44. The component of clause 43, wherein the deriving of the title score for the title associated with the digital identity is based on a weighting of each title score of the set of title scores is that is based on a similarity confidence level between the title associated with the digital identity and the respective title from the set of titles.

Clause 45. The component of any of clauses 43 to 44, wherein the tokenizing comprises extracting, from each title in the set of titles, one or more responsibility tokens, one or more function tokens, one or more scope tokens, or any combination thereof, and assigning each extracted token a respective token score.

Clause 46. The component of any of clauses 43 to 45, wherein the ML model comprises a neutral network (NN).

Clause 47. The component of any of clauses 41 to 46, wherein the determination of the job criticality of the digital identity comprises: means for deriving a management score for the digital identity based on a number of digital identities in the first set of digital identities, the second set of digital identities, or both, wherein the job criticality of the digital identity is a function of the management score.

Clause 48. The component of any of clauses 41 to 47, wherein the job criticality of the digital identity is based on: a role score that is based on the role associated with the digital identity, a title score that is based on the title associated with the digital identity, and a management score that is based on the management structure associated with the digital identity.

Clause 49. The component of any of clauses 41 to 48, wherein the role associated with the digital identity is defined in accordance with a role based access control (RBAC) system.

Clause 50. The component of any of clauses 41 to 49, wherein the title is input as a string and the job criticality is output as a numeric value or a numeric label.

Clause 51. The component of any of clauses 41 to 50, wherein the set of permissions associated with at least one asset, a network, or both, comprises a set of entitlements.

Clause 52. The component of clause 51, wherein each entitlement of the set of entitlements is associated with one or more actions permitted in association with the at least one asset, the network, or both.

Clause 53. The component of clause 52, wherein the one or more actions comprise a read action, a restricted read action, a write action, a delete action, a restore action, an enable action, a disable action, an update action, a manage action, or any combination thereof.

Clause 54. The component of any of clauses 52 to 53, wherein the one or more actions are each ranked in accordance with an action ranking table.

Clause 55. The component of any of clauses 52 to 54, further comprising: means for deriving an entitlement score based on the set of entitlements, wherein the determination of the job criticality of the digital identity is based on the entitlement score.

Clause 56. The component of clause 55, wherein the entitlement score is derived based on a neural network applied with respect to each of the one or more actions.

Clause 57. The component of clause 56, wherein the neural network outputs an embedding for each of the one or more actions, wherein each embedding comprises a vector that encodes semantic information of the respective action in a mathematical space.

Clause 58. The component of clause 57, wherein each embedding is input to a clustering algorithm that assigns each action to a cluster in a set of clusters, wherein each cluster is associated with a particular group of similar actions, wherein each cluster is associated with a cluster score, and wherein each cluster score for each action is factored into the respective entitlement score.

Clause 59. The component of any of clauses 41 to 58, wherein the job criticality of the digital identity is not based on any vulnerability or exploit associated with the at least one asset, the network, or both.

Clause 60. The component of any of clauses 41 to 59, wherein the one or more security functions comprise: means for allocating a job criticality-based priority to vulnerability and/or exploit remediation to one or more assets associated with the digital identity.

Clause 61. A non-transitory computer-readable medium storing computer-executable instructions that, when executed by a component, cause the component to: determine a role associated with a digital identity, the role comprising a set of permissions associated with at least one asset, a network, or both; determine a title associated with the digital identity; determine a set of titles that are analogous to the title associated with the digital identity; determine a management structure associated with the digital identity, the management structure comprising a first set of digital identities subordinate to the digital identity, a second set of digital identities to which the digital identity is subordinate, or a combination thereof; determine a job criticality of the digital identity based on the role associated with the digital identity, the title associated with the digital identity, the set of titles that are analogous to the title associated with the digital identity, and the management structure associated with the digital identity; and perform one or more security functions based on the job criticality of the digital identity.

Clause 62. The non-transitory computer-readable medium of clause 61, wherein the determination of the job criticality of the digital identity comprises: determine a set of scores associated with the set of permissions; and derive a role score based on the set of scores, wherein the job criticality of the digital identity is a function of the role score.

Clause 63. The non-transitory computer-readable medium of any of clauses 61 to 62, wherein the determination of the job criticality of the digital identity comprises: generate the set of titles that are that are analogous to the title associated with the digital identity using a machine-learning (ML) model; tokenize each title in the set of titles via a natural language processing (NPL) model to produce a set of token scores associated with each extracted token; derive a set of title scores for the set of titles based on the set of token scores for the respective title; and derive a title score for the title associated with the digital identity based on the set of title scores, wherein the job criticality of the digital identity is a function of the title score.

Clause 64. The non-transitory computer-readable medium of clause 63, wherein the deriving of the title score for the title associated with the digital identity is based on a weighting of each title score of the set of title scores is that is based on a similarity confidence level between the title associated with the digital identity and the respective title from the set of titles.

Clause 65. The non-transitory computer-readable medium of any of clauses 63 to 64, wherein the tokenizing comprises extracting, from each title in the set of titles, one or more responsibility tokens, one or more function tokens, one or more scope tokens, or any combination thereof, and assigning each extracted token a respective token score.

Clause 66. The non-transitory computer-readable medium of any of clauses 63 to 65, wherein the ML model comprises a neutral network (NN).

Clause 67. The non-transitory computer-readable medium of any of clauses 61 to 66, wherein the determination of the job criticality of the digital identity comprises: derive a management score for the digital identity based on a number of digital identities in the first set of digital identities, the second set of digital identities, or both, wherein the job criticality of the digital identity is a function of the management score.

Clause 68. The non-transitory computer-readable medium of any of clauses 61 to 67, wherein the job criticality of the digital identity is based on: a role score that is based on the role associated with the digital identity, a title score that is based on the title associated with the digital identity, and a management score that is based on the management structure associated with the digital identity.

Clause 69. The non-transitory computer-readable medium of any of clauses 61 to 68, wherein the role associated with the digital identity is defined in accordance with a role based access control (RBAC) system.

Clause 70. The non-transitory computer-readable medium of any of clauses 61 to 69, wherein the title is input as a string and the job criticality is output as a numeric value or a numeric label.

Clause 71. The non-transitory computer-readable medium of any of clauses 61 to 70, wherein the set of permissions associated with at least one asset, a network, or both, comprises a set of entitlements.

Clause 72. The non-transitory computer-readable medium of clause 71, wherein each entitlement of the set of entitlements is associated with one or more actions permitted in association with the at least one asset, the network, or both.

Clause 73. The non-transitory computer-readable medium of clause 72, wherein the one or more actions comprise a read action, a restricted read action, a write action, a delete action, a restore action, an enable action, a disable action, an update action, a manage action, or any combination thereof.

Clause 74. The non-transitory computer-readable medium of any of clauses 72 to 73, wherein the one or more actions are each ranked in accordance with an action ranking table.

Clause 75. The non-transitory computer-readable medium of any of clauses 72 to 74, further comprising computer-executable instructions that, when executed by the component, cause the component to: derive an entitlement score based on the set of entitlements, wherein the determination of the job criticality of the digital identity is based on the entitlement score.

Clause 76. The non-transitory computer-readable medium of clause 75, wherein the entitlement score is derived based on a neural network applied with respect to each of the one or more actions.

Clause 77. The non-transitory computer-readable medium of clause 76, wherein the neural network outputs an embedding for each of the one or more actions, wherein each embedding comprises a vector that encodes semantic information of the respective action in a mathematical space.

Clause 78. The non-transitory computer-readable medium of clause 77, wherein each embedding is input to a clustering algorithm that assigns each action to a cluster in a set of clusters, wherein each cluster is associated with a particular group of similar actions, wherein each cluster is associated with a cluster score, and wherein each cluster score for each action is factored into the respective entitlement score.

Clause 79. The non-transitory computer-readable medium of any of clauses 61 to 78, wherein the job criticality of the digital identity is not based on any vulnerability or exploit associated with the at least one asset, the network, or both.

Clause 80. The non-transitory computer-readable medium of any of clauses 61 to 79, wherein the one or more security functions comprise: allocate a job criticality-based priority to vulnerability and/or exploit remediation to one or more assets associated with the digital identity.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method of operating a component, comprising:
determining a role associated with a digital identity, the role comprising a set of permissions associated with at least one asset, a network, or both;
determining a title associated with the digital identity;
determining a set of titles that are analogous to the title associated with the digital identity;
determining a management structure associated with the digital identity, the management structure comprising a first set of digital identities subordinate to the digital identity, a second set of digital identities to which the digital identity is subordinate, or a combination thereof;
determining a job criticality of the digital identity based on the role associated with the digital identity, the title associated with the digital identity, the set of titles that are analogous to the title associated with the digital identity, and the management structure associated with the digital identity; and
performing one or more security functions based on the job criticality of the digital identity.

2. The method of claim 1, wherein the determination of the job criticality of the digital identity comprises:
determining a set of scores associated with the set of permissions; and
deriving a role score based on the set of scores,
wherein the job criticality of the digital identity is a function of the role score.

3. The method of claim 1, wherein the determination of the job criticality of the digital identity comprises:
generating the set of titles that are that are analogous to the title associated with the digital identity using a machine-learning (ML) model;
tokenizing each title in the set of titles via a natural language processing (NPL) model to produce a set of token scores associated with each extracted token;
deriving a set of title scores for the set of titles based on the set of token scores for the respective title; and
deriving a title score for the title associated with the digital identity based on the set of title scores,
wherein the job criticality of the digital identity is a function of the title score.

4. The method of claim 3, wherein the deriving of the title score for the title associated with the digital identity is based on a weighting of each title score of the set of title scores is that is based on a similarity confidence level between the title associated with the digital identity and the respective title from the set of titles.

5. The method of claim 3, wherein the tokenizing comprises extracting, from each title in the set of titles, one or more responsibility tokens, one or more function tokens, one or more scope tokens, or any combination thereof, and assigning each extracted token a respective token score.

6. The method of claim 3, wherein the ML model comprises a neutral network (NN).

7. The method of claim 1, wherein the determination of the job criticality of the digital identity comprises:
deriving a management score for the digital identity based on a number of digital identities in the first set of digital identities, the second set of digital identities, or both,
wherein the job criticality of the digital identity is a function of the management score.

8. The method of claim 1, wherein the job criticality of the digital identity is based on:
a role score that is based on the role associated with the digital identity,
a title score that is based on the title associated with the digital identity, and
a management score that is based on the management structure associated with the digital identity.

9. The method of claim 1, wherein the role associated with the digital identity is defined in accordance with a role based access control (RBAC) system.

10. The method of claim 1, wherein the title is input as a string and the job criticality is output as a numeric value or a numeric label.

11. The method of claim 1, wherein the set of permissions associated with at least one asset, a network, or both, comprises a set of entitlements.

12. The method of claim 11, wherein each entitlement of the set of entitlements is associated with one or more actions permitted in association with the at least one asset, the network, or both.

13. The method of claim 12, wherein the one or more actions comprise a read action, a restricted read action, a write action, a delete action, a restore action, an enable action, a disable action, an update action, a manage action, or any combination thereof.

14. The method of claim 12, wherein the one or more actions are each ranked in accordance with an action ranking table.

15. The method of claim 12, further comprising:
deriving an entitlement score based on the set of entitlements,
wherein the determination of the job criticality of the digital identity is based on the entitlement score.

16. The method of claim 15, wherein the entitlement score is derived based on a neural network applied with respect to each of the one or more actions.

17. The method of claim 16,
wherein the neural network outputs an embedding for each of the one or more actions,
wherein each embedding comprises a vector that encodes semantic information of the respective action in a mathematical space.

18. The method of claim 17,
wherein each embedding is input to a clustering algorithm that assigns each action to a cluster in a set of clusters,
wherein each cluster is associated with a particular group of similar actions,
wherein each cluster is associated with a cluster score, and
wherein each cluster score for each action is factored into the respective entitlement score.

19. The method of claim 1, wherein the job criticality of the digital identity is not based on any vulnerability or exploit associated with the at least one asset, the network, or both.

20. The method of claim 1, wherein the one or more security functions comprise:
allocating a job criticality-based priority to vulnerability and/or exploit remediation to one or more assets associated with the digital identity.

21. A component, comprising:
one or more memories; and
one or more processors communicatively coupled to the one or more memories, the one or more processors, either alone or in combination, configured to:
determine a role associated with a digital identity, the role comprising a set of permissions associated with at least one asset, a network, or both;
determine a title associated with the digital identity;
determine a set of titles that are analogous to the title associated with the digital identity;
determine a management structure associated with the digital identity, the management structure comprising a first set of digital identities subordinate to the digital identity, a second set of digital identities to which the digital identity is subordinate, or a combination thereof;
determine a job criticality of the digital identity based on the role associated with the digital identity, the title associated with the digital identity, the set of titles that are analogous to the title associated with the digital identity, and the management structure associated with the digital identity; and
perform one or more security functions based on the job criticality of the digital identity.

22. The component of claim 21, wherein the determination of the job criticality of the digital identity comprises:
determine a set of scores associated with the set of permissions; and
derive a role score based on the set of scores,
wherein the job criticality of the digital identity is a function of the role score.

23. The component of claim 21, wherein the determination of the job criticality of the digital identity comprises:
generate the set of titles that are that are analogous to the title associated with the digital identity using a machine-learning (ML) model;
tokenize each title in the set of titles via a natural language processing (NPL) model to produce a set of token scores associated with each extracted token;
derive a set of title scores for the set of titles based on the set of token scores for the respective title; and
derive a title score for the title associated with the digital identity based on the set of title scores,
wherein the job criticality of the digital identity is a function of the title score.

24. The component of claim 21, wherein the determination of the job criticality of the digital identity comprises:
derive a management score for the digital identity based on a number of digital identities in the first set of digital identities, the second set of digital identities, or both,
wherein the job criticality of the digital identity is a function of the management score.

25. The component of claim 21, wherein the job criticality of the digital identity is based on:
a role score that is based on the role associated with the digital identity,
a title score that is based on the title associated with the digital identity, and
a management score that is based on the management structure associated with the digital identity.

26. A component, comprising:
means for determining a role associated with a digital identity, the role comprising a set of permissions associated with at least one asset, a network, or both;
means for determining a title associated with the digital identity;
means for determining a set of titles that are analogous to the title associated with the digital identity;
means for determining a management structure associated with the digital identity, the management structure comprising a first set of digital identities subordinate to the digital identity, a second set of digital identities to which the digital identity is subordinate, or a combination thereof;
means for determining a job criticality of the digital identity based on the role associated with the digital identity, the title associated with the digital identity, the set of titles that are analogous to the title associated with the digital identity, and the management structure associated with the digital identity; and
means for performing one or more security functions based on the job criticality of the digital identity.

27. The component of claim 26, wherein the determination of the job criticality of the digital identity comprises:
means for determining a set of scores associated with the set of permissions; and
means for deriving a role score based on the set of scores,
wherein the job criticality of the digital identity is a function of the role score.

28. The component of claim 26, wherein the determination of the job criticality of the digital identity comprises:
means for generating the set of titles that are that are analogous to the title associated with the digital identity using a machine-learning (ML) model;
means for tokenizing each title in the set of titles via a natural language processing (NPL) model to produce a set of token scores associated with each extracted token;
means for deriving a set of title scores for the set of titles based on the set of token scores for the respective title; and
means for deriving a title score for the title associated with the digital identity based on the set of title scores,
wherein the job criticality of the digital identity is a function of the title score.

29. The component of claim 26, wherein the determination of the job criticality of the digital identity comprises:
means for deriving a management score for the digital identity based on a number of digital identities in the first set of digital identities, the second set of digital identities, or both,
wherein the job criticality of the digital identity is a function of the management score.

30. The component of claim 26, wherein the job criticality of the digital identity is based on:
a role score that is based on the role associated with the digital identity,
a title score that is based on the title associated with the digital identity, and
a management score that is based on the management structure associated with the digital identity.

31. A non-transitory computer-readable medium storing computer-executable instructions that, when executed by a component, cause the component to:
determine a role associated with a digital identity, the role comprising a set of permissions associated with at least one asset, a network, or both;
determine a title associated with the digital identity;
determine a set of titles that are analogous to the title associated with the digital identity;
determine a management structure associated with the digital identity, the management structure comprising a first set of digital identities subordinate to the digital identity, a second set of digital identities to which the digital identity is subordinate, or a combination thereof;
determine a job criticality of the digital identity based on the role associated with the digital identity, the title associated with the digital identity, the set of titles that are analogous to the title associated with the digital identity, and the management structure associated with the digital identity; and
perform one or more security functions based on the job criticality of the digital identity.

32. The non-transitory computer-readable medium of claim 31, wherein the determination of the job criticality of the digital identity comprises:
determine a set of scores associated with the set of permissions; and
derive a role score based on the set of scores,
wherein the job criticality of the digital identity is a function of the role score.

33. The non-transitory computer-readable medium of claim 31, wherein the determination of the job criticality of the digital identity comprises:
generate the set of titles that are that are analogous to the title associated with the digital identity using a machine-learning (ML) model;
tokenize each title in the set of titles via a natural language processing (NPL) model to produce a set of token scores associated with each extracted token;
derive a set of title scores for the set of titles based on the set of token scores for the respective title; and
derive a title score for the title associated with the digital identity based on the set of title scores,
wherein the job criticality of the digital identity is a function of the title score.

34. The non-transitory computer-readable medium of claim 31, wherein the determination of the job criticality of the digital identity comprises:
derive a management score for the digital identity based on a number of digital identities in the first set of digital identities, the second set of digital identities, or both,
wherein the job criticality of the digital identity is a function of the management score.

35. The non-transitory computer-readable medium of claim 31, wherein the job criticality of the digital identity is based on:
a role score that is based on the role associated with the digital identity,
a title score that is based on the title associated with the digital identity, and
a management score that is based on the management structure associated with the digital identity.
